(19) United States
(12) Patent Application Publication
(10) Pub. No.: US 2026/0230814 A1
(43) Pub. Date: Aug. 6, 2026

(54) METHODS AND SYSTEMS FOR COMMUNICATION MANAGEMENT

(71) Applicant: Comcast Cable Communications, LLC, Philadelphia, PA (US)

(72) Inventors: Richard Wikoff, Philadelphia, PA (US); Amare Geremew, Philadelphia, PA (US)

(21) Appl. No.: 19/043,015

(22) Filed: Jan. 31, 2025

(51) Int. Cl. H04W 12/043; H04L 65/1104; H04W 12/06

(52) U.S. Cl. CPC H04W 12/043; H04L 65/1104; H04W 12/06

(57) ABSTRACT

Methods and systems for communication handling and management are described. It may be determined that a call invite message from an originating user device requesting a communication session is missing information such as authentication information. An intermediate communication session may be established to authenticate the originating user device. After the originating user device is authenticated, the intermediate communication session may be terminated and the originally requested communication session may be established.

### BACKGROUND

Communication networks have become increasingly complex, with calls and data often traversing multiple carriers and protocols as they travel from originating devices to terminating networks. This complexity has created challenges in authenticating the identity and legitimacy of calling parties, especially when calls transit networks that may strip or alter authentication information.

As communication networks continue to evolve and incorporate new technologies, the challenge of secure and reliable caller authentication across heterogeneous networks remains a critical area for improvement in the telecommunications industry.

### SUMMARY

It is to be understood that both the following general description and the following detailed description are exemplary and explanatory only and are not restrictive. Methods and systems for authenticating and verifying devices are provided. For example, a device in a terminating network may receive message and determine the message is missing information or that information in the message has been altered. Based on this determination, an intermediary communication session may be established between an originating user device and a desired service device. The various devices may use this intermediate communication session to exchange the missing authentication or verification information and thereby authenticate the originating user device.

### BRIEF DESCRIPTION OF THE DRAWINGS

The accompanying drawings, which are incorporated in and constitute a part of this specification, show examples and together with the description, serve to explain the principles:

FIGS. 1A-1B show an example system;

FIG. 2 shows an example system and method;

FIGS. 3A-3C shows example systems and methods;

FIG. 4 shows an example system and method;

FIGS. 5A-5F show an example system and method;

FIG. 6 shows an example method;

FIG. 7 shows an example method;

FIG. 8 shows an example method;

FIG. 9 shows an example method; and

FIG. 10 shows an example system for communication management.

### DETAILED DESCRIPTION

As used in the specification and the appended claims, the singular forms “a,” “an,” and “the” include plural referents unless the context clearly dictates otherwise. Ranges may be expressed herein as from “about” one particular value, and/or to “about” another particular value. If such a range is expressed, another configuration includes from the one particular value and/or to the other particular value. Similarly, if values are expressed as approximations, by use of the antecedent “about,” it will be understood that the particular value forms another configuration. It will be further understood that the endpoints of each of the ranges are significant both in relation to the other endpoint, and independently of the other endpoint.

“Optional” or “optionally” means that the subsequently described event or circumstance may or may not occur, and that the description includes cases where said event or circumstance occurs and cases where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal configuration. “Such as” is not used in a restrictive sense, but for explanatory purposes.

It is to be understood that if combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

As will be appreciated by one skilled in the art, hardware, software, or a combination of software and hardware may be implemented. Furthermore, a computer program product on a computer-readable storage medium (e.g., non-transitory) having processor-executable instructions (e.g., computer software) embodied in the storage medium. Any suitable computer-readable storage medium may be utilized including hard disks, CD-ROMs, optical storage devices, magnetic storage devices, memresistors, Non-Volatile Random Access Memory (NVRAM), flash memory, or a combination thereof.

Throughout this application reference is made block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general purpose computer, special purpose computer, or other programmable data processing apparatus to produce a machine, such that the processor-executable instructions which execute on the computer or other programmable data processing apparatus create a device for implementing the functions specified in the flowchart block or blocks.

These processor-executable instructions may also be stored in a computer-readable memory that may direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Accordingly, blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

“Content items,” as the phrase is used herein, may also be referred to as “content,” “content data,” “content information,” “content asset,” “multimedia asset data file,” or simply “data” or “information.” Content items may be any information or data that may be licensed to one or more individuals (or other entities, such as business or group). Content may be electronic representations of video, audio, text and/or graphics, which may be but is not limited to electronic representations of videos, movies, or other multimedia, which may be but is not limited to data files adhering to MPEG2, MPEG, MPEG4 UHD, HDR, 4k, Adobe® Flash® Video (. FLV) format or some other video file format whether such format is presently known or developed in the future. The content items described herein may be electronic representations of music, spoken words, or other audio, which may be but is not limited to data files adhering to the MPEG-1 Audio Layer 3 (.MP3) format, Adobe®, CableLabs 1.0,1.1, 3.0, AVC, HEVC, H.264, Nielsen watermarks, V-chip data and Secondary Audio Programs (SAP). Sound Document (.ASND) format or some other format configured to store electronic audio whether such format is presently known or developed in the future. In some cases, content may be data files adhering to the following formats: Portable Document Format (.PDF), Electronic Publication (. EPUB) format created by the International Digital Publishing Forum (IDPF), JPEG (.JPG) format, Portable Network Graphics (.PNG) format, dynamic advertisement insertion data (.csv), Adobe® Photoshop® (.PSD) format or some other format for electronically storing text, graphics and/or other information whether such format is presently known or developed in the future. Content items may be any combination of the above-described formats.

This detailed description may refer to a given entity performing some action. It should be understood that this language may in some cases mean that a system (e.g., a computer) owned and/or controlled by the given entity is actually performing the action.

The present methods and systems provide an improvement in communications technologies and related technologies.

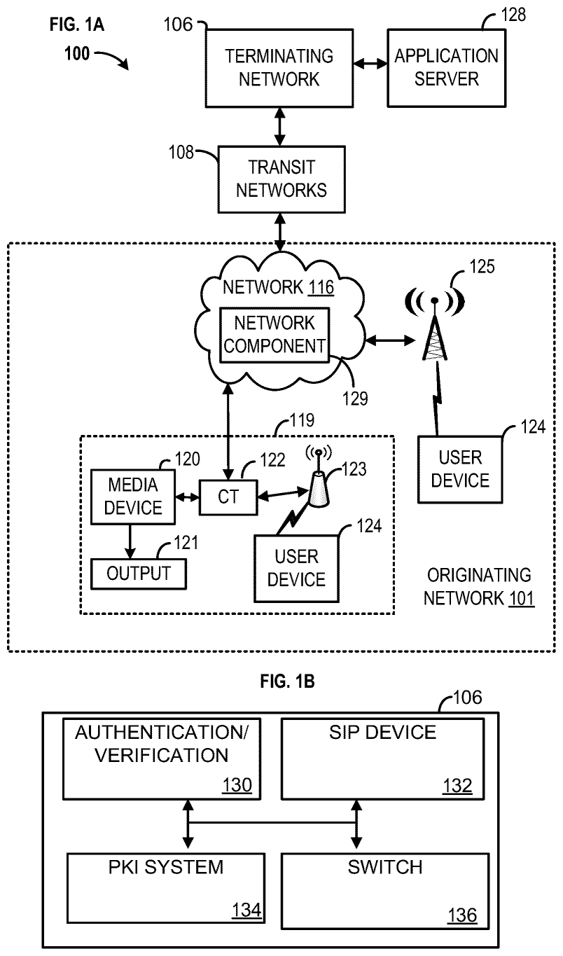

FIG. 1 shows a system 100 for communication management. Those skilled in the art will appreciate that digital equipment and/or analog equipment may be employed. Those skilled in the art will appreciate that provided herein is a functional description and that the respective functions may be performed by software, hardware, or a combination of software and hardware.

The system 100 may comprise an originating network 101, a terminating network 106, one or transit networks 108, and one or more application servers 128 configured to provide one or more services. The one or more application servers 128, while shown separate from the terminating network 106, may be part of (e.g., hosted by a device in) the terminating network 106.

Although network 116 is shown in the originating network 101, the illustration is merely exemplary and explanatory and not limiting. For example, the network 116 may be an intermediary network (e.g., a transit network) between the originating network 101 and the terminating network 106. The system 100 may comprise an originating user device 124 in the originating network. The one or more application servers 128 may be associated with the terminating network 106. The originating network 101 may comprise a media device 120, an output device 121, a communications terminal 122, a first access point 123, a second access point 125 (e.g., a headend, fiber optic, or satellite communications facility), various other devices, combinations thereof, and the like.

The network 116 may facilitate sending data to and from the various devices of the system 100. The network 116 may be a telecommunications network, a content delivery network, a content access network, combinations thereof, and the like. The network may be managed (e.g., deployed, serviced) by a content provider, a service provider (e.g., a mobile network operator), combinations thereof, and the like. The network 116 may be a plain-old telephony (POTS) network, a wireless cellular network, an optical fiber network, a coaxial cable network, a hybrid fiber-coaxial network, a wireless network, a satellite system, a direct broadcast system, or any combination thereof. The network 116 can be the Internet. The network 116 may have a network component 129. The network component 129 may be any device, module, combinations thereof, and the like communicatively coupled to the network 116. The network component 129 may be a router, a switch, a splitter, a packager, a gateway, an encoder, a storage device, a multiplexer, a network access location (e.g., tap), physical link, combinations thereof, and the like.

The user device 124 may comprise one or more of a cell phone, a smart phone, a laptop computer, a desktop computer, a tablet, a virtual assistant device, a plain old telephone (POTS), combinations thereof and the like.

The user device 124 may be configured to send one or more messages. For example, the user device 124 may be configured to send one or more session invite messages. The one or more session invite messages may comprise one or more requests for one or more services provided by or otherwise associated with the one or more application servers 128. For example, the one or more session invites may comprise one or more SIP messages.

As used herein, the term “incoming” refers to a point of view of the device and/or network receiving the call. For example, if the user device 124 sends a message towards the one or more application servers 128, from the one or more application servers 128's perspective, the message may be “incoming.” The term “outgoing” may refer to the same call, but from the point of view of the device placing the call (e.g., the user device 124) and/or the network associated with the device sending the message (e.g., the originating network 101). However, the one or more application servers 128, terminating network 106 (and/or one or more devices associated therewith), the one or more transit networks 108 (and/or one or more devices associated therewith) may send a message (e.g., an outgoing message) towards the originating network 101 and/or the user device 124 may receive the message as an incoming message.

The message may be sent by a user device (e.g., a user associated with the user device may dial a number). The outgoing message may be sent via one or more first protocols. For example, the one or more first protocols may comprise one or more of: Plain Old Telephony Service (POTS), WebRTC, HTTP/HTTPS, email or other messaging service, push notifications, one or more data fetches, and/or an SIP protocol message. For example, the message may be placed automatically in response to a wake word or other similar trigger. The call may comprise one or more of: a session initiation protocol (SIP) invite, a plain old telephony service (POTS) call, voice over internet protocol (VOIP) call, video call, cellular call, voice over LTE call, Wi-Fi call, application message, push-to-talk (PTT) call, or emergency network call.

The message may comprise one or more identifiers and/or authentication/verification information. For example, the one or more identifiers may be associated with the device sending the message (e.g., one or more device identifiers, one or more user identifiers, one or more message identifiers, one or more session identifiers, combinations thereof, and the like). For example, the message may comprise authentication/verification information.

For example, the authentication/verification information may comprise user credentials (e.g., usernames, passwords), which may be contained within an Authorization header. This header, along with the Proxy-Authorization header for requests passing through proxies, may be configured for digest authentication via parameters like nonces and responses. Additionally, secure tokens, such as OAuth tokens or JSON Web Tokens (JWT), may be included for broader authentication purposes. The authentication/verification information may comprise a unique call identifier (Call-ID, SIP ID) that helps track sessions and bolster security. The authentication/verification information may comprise TLS (Transport Layer Security) information, including certificates and associated fingerprints or hashes, providing encrypted channels and verification. For example, the authentication/verification information may comprise PKI (Public Key Infrastructure) information, such as digital signatures or public key certificates, may also appear to authenticate the sender and ensure message integrity.

For example, the authentication/verification information may comprise one or more timestamps and/or nonces to guard against replay attacks, as well as source IP addresses and port information for network-level verification. The authentication/verification information may comprise caller ID data, which may be combined with verification protocols like STIR/SHAKEN, and media access control (MAC) addresses to serve as additional authentication layers. The authentication/verification information may comprise one or more SIP headers dedicated to encryption key exchanges, such as Security-Client, Security-Server, and Security-Verify. The authentication/verification information may comprise device fingerprinting and user-agent information to help identify the originating client software or device for verification purposes. The authentication/verification information may comprise one or more access tokens issued by authentication servers. The authentication/verification information may comprise one or more authentication service headers (Auth-Info).

The message may comprise supplemental data. For example, the supplemental data may comprise caller ID data, call parameter data, session description data, media negotiation data, network address data, call routing data, presence data, service-specific data, and/or error and status data. For example, in a VoIP invite or call initiation message, various supplemental data elements may be included to manage and facilitate the communication session. For example, the caller ID data may comprise essential information about the caller, such as their name, phone number, or username. For example, the call parameters may be conveyed to specify settings like call type (voice, video, conference), priority, supported codecs, and preferred media formats. For example, the session description may be provided, delineating session characteristics such as duration, start and end times, and any associated scheduling details. For example, media negotiation information is exchanged to determine compatible codecs, media formats, and bandwidth constraints between parties. For example, the network addressing information, including IP addresses and ports, may be shared to establish the connection between the calling and called parties. For example, the authentication and security details, encompassing mechanisms, encryption algorithms, and protocols used to secure the session, may be communicated. For example, the call routing information may be communicated to indicate the path and network elements involved in connecting the parties, including gateways or proxies. For example, the presence information may convey the availability status of the caller, indicating whether they are reachable at the moment. Additionally, service-specific data such as call history, recording preferences, or customized features may be included. Further, error and status codes may be transmitted to communicate the outcome of the call initiation process, indicating success, failure, or encountered errors.

The one or more transit networks 108 may comprise one or more SIP legs, one or more TDM legs, combinations thereof, and the like. The one or more transit networks may comprise one or more SIP (Session Initiation Protocol) legs (and/or devices associated therewith) as well as one or more TDM (Time Division Multiplexing) legs (and/or devices associated therewith). This combination may enable interoperability between varying protocols and technologies. For example, an SIP leg may utilize IP-based protocols for voice and multimedia sessions. Operating over packet-switched networks, the SIP leg may be configured for the exchange of SIP messages to establish, maintain, and terminate communication sessions. The one or more SIP legs may comprise one or more SIP proxies, which may be configured to direct SIP messages between endpoints and network elements, one or more SIP registrars, which may be configured to authenticate and locate endpoints, and one or more SIP gateways, which may be configured to translate SIP signaling to other protocols, such as TDM.

The one or more TDM legs may comprise one or more segments of communication transmitted over circuit-switched networks, (e.g., commonly used for traditional telephony). The one or more TDM legs (and/or devices associated therewith) may be configured to divide communication channels into time slots, providing a fixed bandwidth for voice and data transmission. The one or more TDM legs may comprise one or more circuit switches, which may be configured to establish a dedicated communication path for each call, one or more multiplexers, which may be configured to combine multiple signals for transmission over a single channel, and one or more TDM-to-IP gateways, which may be configured to convert TDM signals into IP packets for compatibility with SIP-based networks. The one or more transit networks may comprise one or more switches. The one or more switches may comprise various components within a cellular network infrastructure, facilitating the routing of calls, data, and other communication signals between different network components. For example, among these components may be the Mobile Switching Center (MSC), responsible for managing call setup, routing, termination, and mobility management between mobile devices and external networks such as the Public Switched Telephone Network (PSTN). The one or more switches may comprise a Base Station Controller (BSC) configured to oversee multiple Base Transceiver Stations (BTS) and manage radio resources and handovers. In modern networks like 4G LTE and 5G, packet switches are essential for handling data traffic, ensuring the smooth transmission of data packets between various network elements. These switches collectively manage voice and data traffic, optimize network resources, and uphold reliable connectivity for users across the cellular network.

The terminating network 106 may receive the incoming call. The terminating network 106 may comprise one or more of an authentication/verification device 130, an SIP device 132, a PKI system 134, and/or a switch 136 (as shown in FIG. 1B).

The authentication/verification device 130 (e.g., a STIR/SHAKEN server) may be a separate device. The authentication/verification device 130 may be configured to implement the Secure Telephone Identity Revisited (STIR) and Signature-based Handling of Asserted Information Using toKENs (SHAKEN) framework, which authenticate and verify caller identities. This process involves digitally signing caller information and transmitting it across the network to ensure its integrity and authenticity. For example, when a call is initiated, an originating service provider (e.g., OSP associated with the originating user device 124 and/or originating network 101) may send a call setup request and uses a STIR/SHAKEN authentication service to generate a digital certificate. The digital certificate contains information about the calling party's number and the OSP's identity, which is then signed using a private key to create a digital signature.

The authentication/verification device 130 may determine if the incoming call contains authentication/verification information. If the incoming message comprises authentication/verification information, the authentication/verification device may process the authentication/verification information. For example, the authentication/verification device 130 may parse or otherwise determine information (e.g., data) in one or more fields and/or one or more headers in the message. The authentication/verification device 130 may also determine the incoming message does not include authentication/verification information. For example, the authentication/verification information may be lost or altered as the incoming message transits the one or more transit networks (e.g., due to protocol conversion from SIP to ISUP, due to packet loss, or for other reasons).

The SIP device 132 may be configured to facilitate Session Initiation Protocol (SIP) communications, which are typically used for initiating, maintaining, and terminating real-time voice, video, and messaging sessions over IP networks. For example, SIP device 132 may comprise a hardware endpoint such as a VoIP phone, a software-based SIP client on a computer, or a mobile application, each tailored to handle SIP-based signaling.

The SIP device 132 may be configured to send and receive SIP messages such as INVITE, ACK, BYE, and REGISTER requests, enabling it to establish and manage communication sessions. For example, it may comprise a user agent client (UAC) to initiate a session and a user agent server (UAS) to respond to incoming session requests. The device may also handle message routing, for instance, by connecting to a SIP proxy server to facilitate signaling between endpoints and manage the flow of SIP messages.

The SIP device 132 may comprise mechanisms for Transport Layer Security (TLS) encryption of SIP messages, as well as Secure Real-Time Transport Protocol (SRTP) for the protection of media streams. It may be configured to perform authentication and authorization through SIP headers such as Authorization and WWW-Authenticate, validating users and sessions to prevent unauthorized access.

The SIP device 132 may support various features, including call setup, session modification (such as placing a call on hold or changing media types), and session teardown. For example, it may be configured to handle re-INVITE requests during a call to change media parameters or transfer sessions to new endpoints using REFER messages. Additionally, it may comprise interoperability capabilities with other SIP devices and legacy telephony systems through media gateways, ensuring compatibility across different communication platforms.

The PKI system 134, may comprise one or more components (not necessarily shown in figure). For example, the PKI system 134 may comprise a certificate authority (CA). The certificate authority may be configured to issue, validate, and/or revoke digital certificates for entities such as individuals, organizations, or devices. For example, the CA may comprise a root CA, serving as the trust anchor for a PKI, and one or more subordinate CAs to distribute load and enforce specific certificate policies. Supporting the CA, a Registration Authority (RA) may act as an intermediary between the user and the CA, verifying the identity of entities requesting certificates before forwarding approved requests to the CA for issuance.

The PKI system 134 may comprise or otherwise be associated with a Certificate Revocation List (CRL). The CRL may comprise a periodically updated list of revoked certificates published by the CA. The PKI system 134 may comprise or otherwise be configured with or associated with an Online Certificate Status Protocol (OCSP). The OCSP may be configured to provide real-time certificate status verification without requiring a full list download.

The PKI system 134 may be configured to process one or more keys (e.g., one or more public keys and/or one or more private keys). For example, the one or more public keys may be openly distributed while the one or more private keys may be kept secret. The PKI system 134 may be configured to process one or more digital certificates. The one or more digital certificates may be configured to bind a public key to an identity, comprise details such as the subject's name, the public key, the CA's digital signature, and a validity period. For example, digital certificates authenticate users or devices and help establish secure communication channels. PKI also incorporates a trust model, which may be hierarchical, where subordinate entities are trusted based on a chain of trust starting from the root CA, or decentralized, like a web-of-trust model, enabling distributed trust relationships among entities.

The PKI system 134 may comprise or otherwise be associated with or configured to process one or more Certification Practice Statements (CPS) and/or one or more certificate policies. The one or more CPSs and/or one or more certificate policies may be configured to define procedures and rules governing the issuance and management of certificates. For example, a CPS may specify authentication requirements, while certificate policies may address specific use cases or security levels. End-entities, such as users, devices, or applications, may be configured to use their certificates and key pairs for secure operations such as email encryption, digital signing, or establishing secure connections.

The PKI system 134 may be configured to generate one or more certificates. For example, a carrier (e.g., MNO) may generated a certificate signing request (CSR). The CSR may comprise the carrier's public key and identifying information (e.g., common name, organization, etc.). The CSR may be sent to the CA (the CA may or may not be industry specific). The CA may verify the carrier's identity and other information. If verified, the CA may sign the certificate with its own private key, thereby creating a signed digital certificate. The CA may return the signed certificate to the carrier. The carrier may share (e.g., send) the certificate which now comprises (the carrier's public key, the carrier's identifying information, and the CA's digital signature.

The PKI system 134 may store one or more private keys (e.g., in Hardware Security Modules (HSMs)). The PKI system 134 may store one or more public certificates (e.g., in X.509 format). The PKI system 134 may comprise one or more distributed databases accessible by all carriers or only some carriers in a network. The PKI system 134 may comprise a central repository maintained by a trusted industry body. Each carrier associated with the PKI system 134 may also be associated with local storage limited to that carrier.

The one or more application servers 128 may be configured to provide, to a requesting user device (e.g., the user device 124), one or more services. The one or more application servers 128 may be hosted on or otherwise be associated with an application server. The application server may be configured to provide the service. For example, the one or more requested services (e.g., requested by the one or more originating user devices) comprise an interactive voice response (IVR) service, a chatbot service, a virtual assistant service, a call routing service, an auto-attendant service, an SMS service, an email service, a video streaming service, a customer relationship management (CRM) service, a speech recognition service, an interactive text response (ITR) service, an automatic call distribution (ACD) service, one or more artificial intelligence services, combinations thereof, and the like.

The one or more application servers 128 may be configured to initiate the establishment of an intermediary communication session (e.g., a communication session subsequent to an initial request for a communication session as sent, for example, by the user device 124). For example, based on a determination that a first message invite sent by the user device 124 requesting a service from the application server 128, a second session invite message may be sent. The second session invite message may be sent, for example, by the application server 128. The second session invite message may comprise an SIP invite. The second session invite message may comprise an authentication challenge request.

Returning to the components of system 100, the media device 120 may be configured to receive content and other associated data (e.g., metadata). The media device 120 may comprise a user device such as an STB, computer, mobile phone, combinations thereof, and the like. The media device 120 may be a digital streaming device, a gaming device, a media storage device, a digital recording device, a computing device, a mobile computing device (e.g., a laptop, a smartphone, a tablet, etc.), combinations thereof, and the like.

The media device 120 may comprise a demodulator, decoder, frequency tuner, combinations thereof, and the like. The media device 120 may be directly connected to the network (e.g., for communications via in-band and/or out-of-band signals of a content delivery network) and/or connected to the network 116 via a communication terminal 122 (e.g., for communications via a packet switched network). The media device 120 may implement one or more applications, such as content viewers, social media applications, news applications, gaming applications, content stores, electronic program guides, combinations thereof, and the like. Those skilled in the art will appreciate that the signal may be demodulated and/or decoded in a variety of equipment, including the communication terminal 122, a computer, a TV, a monitor, or a satellite dish. The communication terminal 122 may be located at the user location 119. The communication terminal 122 may be configured to communicate with the network 116. The communication terminal 122 may be a modem (e.g., cable modem), a router, a gateway, a switch, a network terminal (e.g., optical network unit), combinations thereof, and the like. The communication terminal 122 may be configured for communication with the network 116 via a variety of protocols, such as IP, transmission control protocol, file transfer protocol, session initiation protocol, voice over IP (e.g., VoIP), combinations thereof, and the like. The communication terminal 122, for a cable network, may be configured to facilitate network access via a variety of communication protocols and standards, such as Data Over Cable Service Interface Specification (DOCSIS).

A first access point 123 (e.g., a wireless access point) may be located at the user location 119. The first access point 123 may be configured to provide one or more wireless networks in at least a portion of the user location 119. The first access point 123 may be configured to facilitate access to the network 116 to devices configured with a compatible wireless radio, such as a mobile device 124, the media device 120, the display device 121, or other computing devices (e.g., laptops, sensor devices, security devices). The first access point 123 may be associated with a user managed network (e.g., local area network), a service provider managed network (e.g., public network for users of the service provider), combinations thereof, and the like. It should be noted that in some configurations, some or all of the first access point 123, the communication terminal 122, the media device 120, and the display device 121 may be implemented as a single device.

The user location 119 is not necessarily fixed. A user may receive content from the network 116 on the mobile device 124. The mobile device 124 may be a laptop computer, a tablet device, a computer station, a personal data assistant (PDA), a smart device (e.g., smart phone, smart apparel, smart watch, smart glasses), GPS, a vehicle entertainment system, a portable media player, a combination thereof, combinations thereof, and the like. The mobile device 124 may communicate with a variety of access points (e.g., at different times and locations or simultaneously if within range of multiple access points), such as the first access point 123 or the second access point 125.

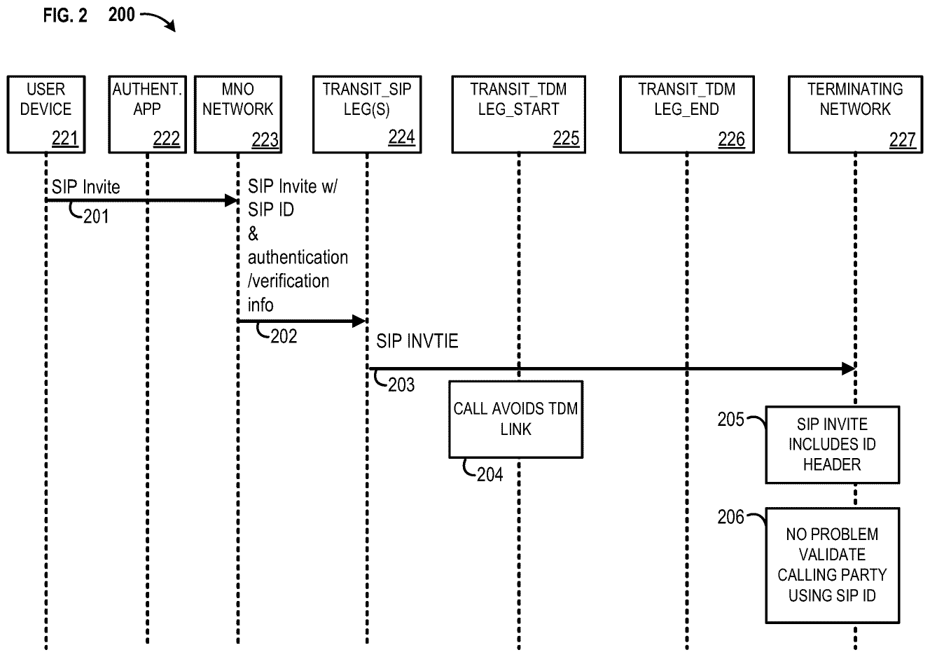

FIG. 2 shows a method and system 200. The system 200 may comprise a user device 221, an authentication application 222 (which may be resident on, or otherwise associated with, the user device 221), a mobile network operator (MNO) network 223, one or more transit networks (e.g., SIP legs 224, TDM leg start 225, TDM leg end 226), and one or more terminating networks 227. The user device 221 may be configured to, at 201, send an SIP invite towards the MNO network 223. At 202, the MNO network may add an SIP ID and/or authentication/verification information to the SIP invite. For example, the authentication/verification information may comprise STIR/SHAKEN information or other authentication/verification information. Also at 202, the MNO network device 223 may send the SIP invite towards the terminating network 227 (e.g., towards any one or more device associated with the terminating network 227 such as a service device). One or more SIP transit legs associated with the one or more transit networks may receive the SIP invite and forward it towards the terminating network 227 (e.g., towards any one or more device associated with the terminating network 227 such as a service device).

In FIG. 2, at 204, the SIP invite may bypass or otherwise avoid the one or more TDM legs and arrive at the terminating network in essentially the same form (e.g., the same protocol) as it left the MNO network 223. The SIP invite may be received by the terminating network 227 and, because the SIP invite includes an SIP header, at 206, the user device 221 (e.g., the calling party) may be validated using the SIP ID.

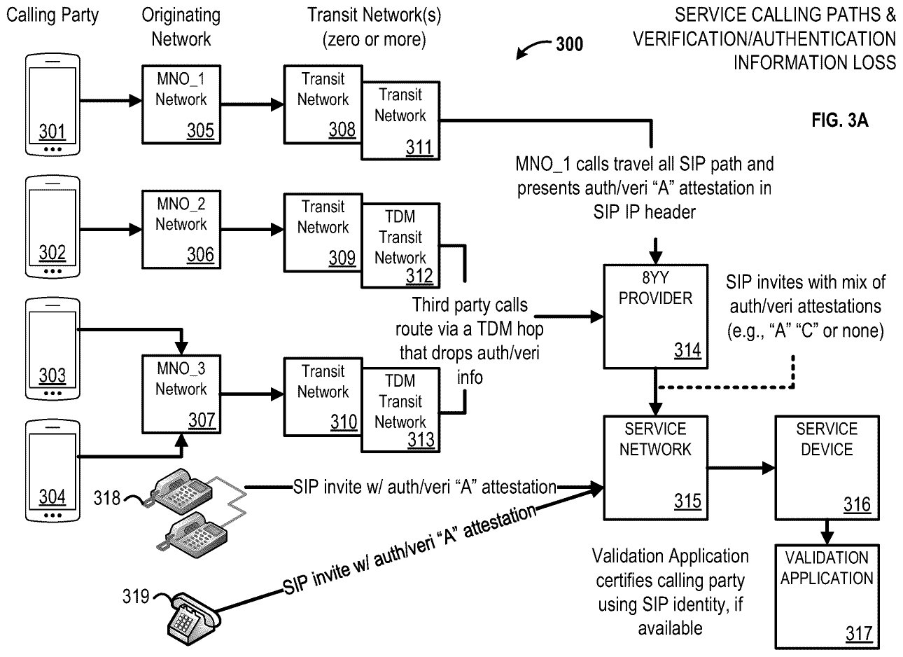

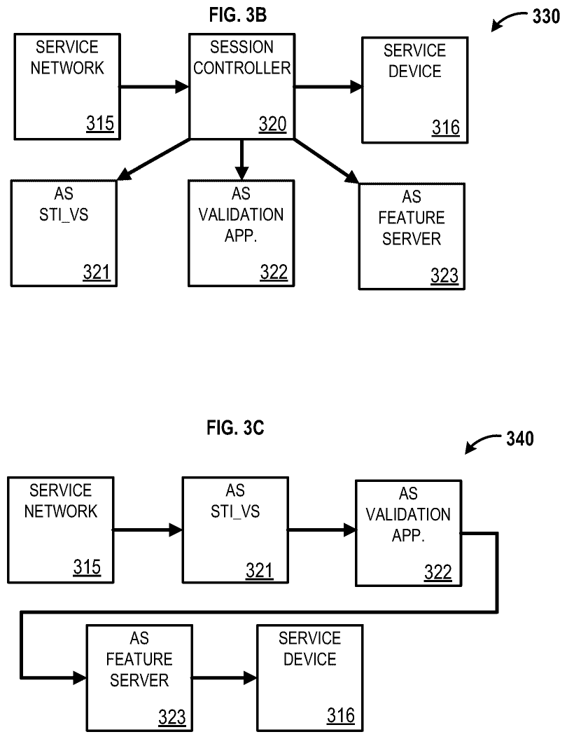

FIG. 3 shows an example system and methods 300. The system may comprise one or more originating user devices (301, 302, 303, and 304). The system may comprise one or more originating networks (e.g., 305, 306, 307). The system may comprise one or more transit networks (e.g., 308, 309, 310, 311, 312, 313) which may or may not be operated by the same MNO(s) that operates any of the one or more originating networks. The system may comprise an 8yy provider device 314, a service network 315, a service device 316, and/or a validation application 317.

The service network 315 (e.g., the terminating network where the requested service is hosted or otherwise accessed) may be associated with the same MNO as any one or more of the originating user devices 301, 302, 303, 304. An MNO or MVNO subscriber may have access to the public and private keys via either the MVNO or MNO (e.g., the MVNO may provide its own service or it may contract a service from the MNO).

The one or more originating user devices may comprise, for example, one or more smart phones, tablets, computers, voice assistants, or other similar communication devices. The one or more originating user devices may configured to various communication protocols. For example, the one or more originating user devices may be configured to communicate via session initiation protocol (SIP). In the method 300, the one or more originating user devices may send one or more first session invite messages. For example, the one or more first session invite messages may comprise one or more SIP invites.

For example, a first originating device 301 of the one or more originating user devices may place a call to a service (e.g., send a first session invite message). As seen in FIG. 3, the first session invite message sent by the first originating user device 301 may be sent to a first transit network 308 and/or a second transit network 311. For example, and as described in the figure, the first session invite message from the first originating user device may travel a path that does not require a conversion of the first session invite message. For example, a first session invite message sent by originating user device 301 may be sent to (and received by) a first mobile network operator device (and/or network associated therewith) 305. The first MNO network device 305 may send the first session invite message to one or more transit networks 308, 311 (and/or one or more devices associated therewith). The one or more transit networks 308, 311 may be configured for the same communications protocol as the first invite message and thus may not need to convert the first invite message to another format. For example, if the first invite message is an SIP invite, the one or more transit networks (and devices associated therewith) may be configured for SIP communication.

Thus, the first session invite message may travel an all SIP network route towards the 8YY provider device 314 and arrive at the 8YY provider device in essentially the same form as it was sent. In this case, the first session invite message may arrive at the 8YY provider device 314 with an authentication/verification “A” attestation indicating the originating user device is authenticated.

As seen in FIG. 3A, messages (e.g., invite messages and other communications) sent by originating user device 302, 303, and 304 may travel one or more networks that may result in the conversion of one or more second session invite messages (sent by the one or more user devices 302, 303, 304) as they transit the path. For example, as described the figure, those calls may transit one or more TDM legs of the path. During transit of the one or more TDM legs (which is purely exemplary and a person skilled in the art will appreciate other protocols are contemplated) the one or more invite messages arriving from the user devices 302, 303, 304 may be converted (e.g., from SIP to ISUP). As a result of conversion from a first format to a second format (e.g., a first protocol to a second protocol), information may be lost. For example, one or more identifiers and/or authentication/verification information in an SIP message may not map to an ISUP message format and thus be altered or lost. As a result, upon arrival at the 8YY provider device 314, the one or more session invite messages sent from the one or more originating user devices 302, 303, 304 may be missing information.

The 8YY provider device 314 may, if an SIP identity is received, be configured to pass the SIP identity to one or more other networks or devices associated with a service (e.g., service networks and/or service devices). The 8YY provider device 314 may be configured to determine, generate, and or insert data into the session invite message. For example, if the message arrives without an SIP ID, the 8YY provider device may insert an SIP ID with a “C” attestation. A “C” attestation indicates the origin of the session invite message cannot be fully verified. The “C” attestation may indicate (and/or the 8YY provider device may be configured to determine) the session invite message has transited the one or more transit networks. For completeness, an “A” attestation (typically the highest level of verification) may indicate (and/or the 8YY provider device may be configured to determine) the originating user device is verified (e.g., the identity is associated with the originating number). A “B” attestation (typically a moderate level of verification) may indicate (and/or the 8YY provider device may be configured to determine) some information about the originating user device and/or originating network, but potentially not enough for full verification.

The 8YY provider device 314 may be configured to send any received session invitation messages to one or more networks and/or devices associated with a service (e.g., a service network 315 and/or a service device 316). The 8YY device 314 may be owned or operated or otherwise controlled by an intermediate carrier and thus may not control call routing.

The service network (e.g., terminating network) may have access to one or more public key infrastructures (PKIs). In the case that one or more originating user devices (e.g., the originating user device 301 and/or 304) is associated with the same MNO as is associated with the service network, one or more devices in the service network may be configured to retrieve the one or more public keys associated with the one or more originating user devices. The one or more public keys may be used to authentication and/or verify the one or more originating user devices.

After the authentication/verification process is complete (as described in greater detail below), the originating user device may be connected to one or more requested services (e.g., hosted at service device 315). For example, the one or more requested services (e.g., requested by the one or more originating user devices) comprise an interactive voice response (IVR) service, a chatbot service, a virtual assistant service, a call routing service, an auto-attendant service, an SMS service, an email service, a video streaming service, a customer relationship management (CRM) service, a speech recognition service, an interactive text response (ITR) service, an automatic call distribution (ACD) service, one or more artificial intelligence services, combinations thereof, and the like.

The service 316 may be in communication with a validation application device 317. The validation application device 317 may be configured to authenticate/verify/validate any of the one or more originating user devices 301, 302, 303, 304. For example, the validation application device 317 may comprise one or more STIR/SHAKEN devices (e.g., a STIR/SHAKEN server). The validation application device 317 may be configured to implement the Secure Telephone Identity Revisited (STIR) and Signature-based Handling of Asserted Information Using toKENs (SHAKEN) framework, which authenticate and verify caller identities. This process involves digitally signing caller information and transmitting it across the network to ensure its integrity and authenticity. For example, when a call is initiated, an originating service provider (e.g., OSP associated with the originating user device and/or originating network) receives a call setup request and uses a STIR/SHAKEN authentication service to generate a digital certificate. The digital certificate contains information about the calling party's number and the OSP's identity, which is then signed using a private key to create a digital signature. User devices 318 and 319 may forego the one or more transit networks.

FIG. 3B shows an example system 330. The system 330 may comprise the service network 315, a session controller 320, the service device 316, an application server (“AS”) secure telephony identity and verification service (STI_VS) 321, an AS validation application 322, and an AS feature server 323. To authenticate/verify a calling device (e.g., the originating user device), a sequence of messages is exchanged between the calling device, Session Controller 320, Application Servers (AS) (e.g., comprising the AS STI_VS 321, the AS validation application 322, and/or the application server feature server 323), and the service device 316. The process may being with the call setup and an initial request (e.g., one of the invite messages). The calling device may send a Session Initiation Request (e.g., SIP INVITE or similar protocol message) to the session controller 320. This request typically contains the caller ID or identity information, device metadata (e.g., IP address, device certificates, tokens), and details about the requested service, such as access to the service device 316.

The AS STI_VS may be configured for identity verification. For example, the session controller 320 may forward identity-related information, such as the caller ID, digital signature, or certificate, to the secure telephony identity verification service 321. The secure telephony identity verification service 321 may validate the calling device's identity by checking against a trusted database or using cryptographic methods. For systems implementing STIR/SHAKEN, the secure telephony identity verification service 321 may validate the Identity Header of the SIP request to confirm it hasn't been tampered with. The AS STI_VS 321 may respond to the session controller 320 with a Verification Response, which may indicate that the identity is “Verified” (authentic), “Unverified” (not authenticated), or “Blocked” (flagged as fraudulent or spoofed).

If the identity verification is successful, token validation may be performed by the AS validation app 322. The session controller 320 may send a token validation request containing information such as the caller identity token or session token, along with metadata like session IDs or timestamps. The AS validation app 322 may verify the token and respond with either a validation success, confirming that the token is authentic and untampered, or a validation failure, indicating that the token is invalid or expired.

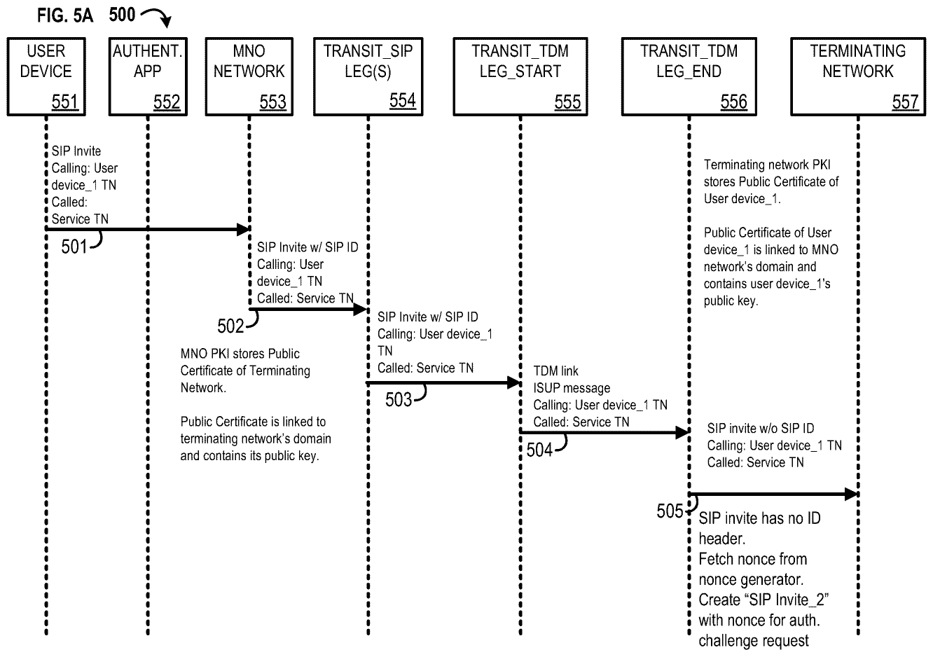

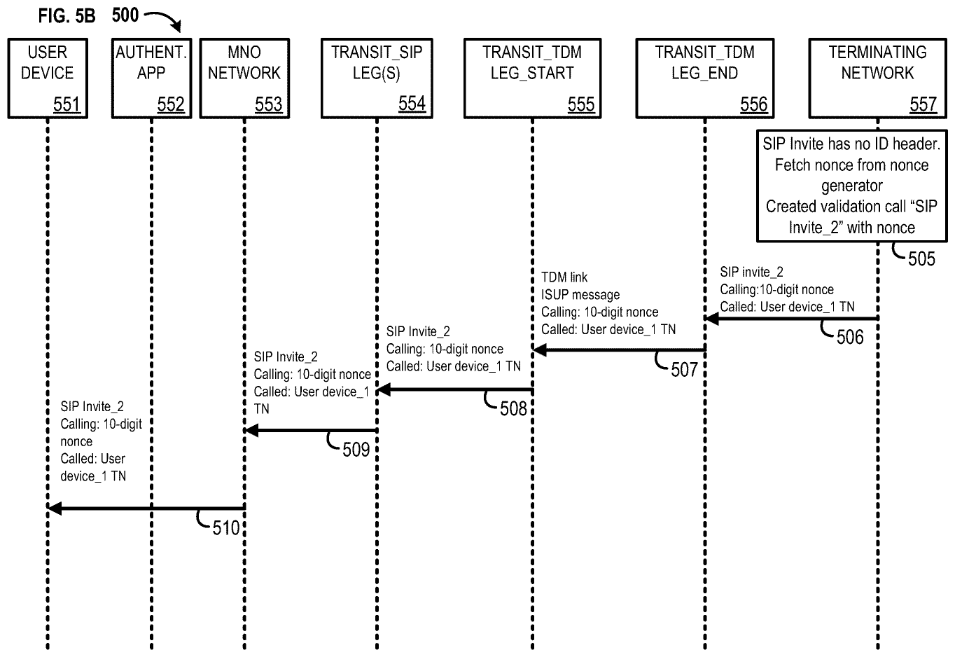

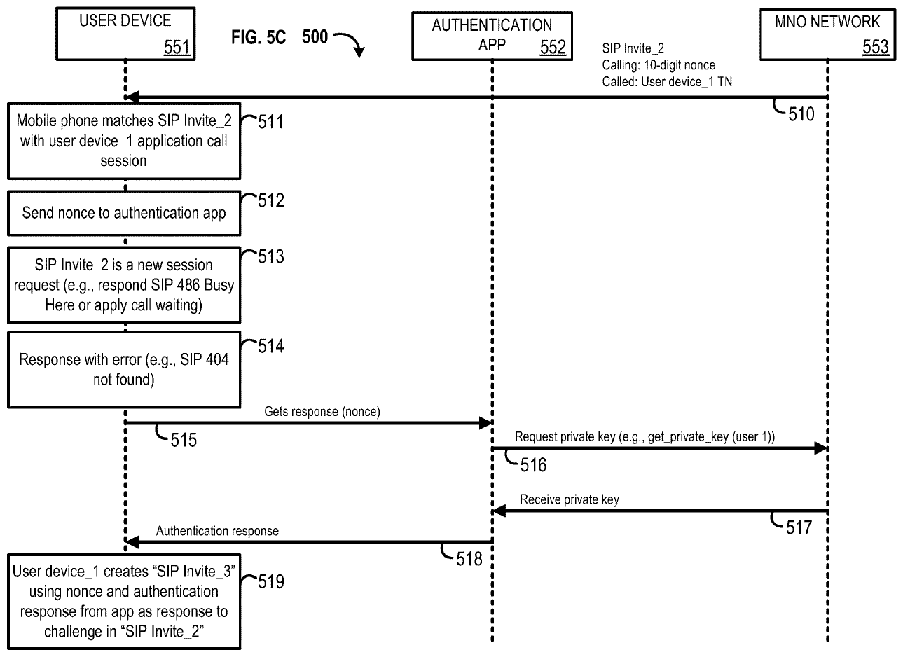

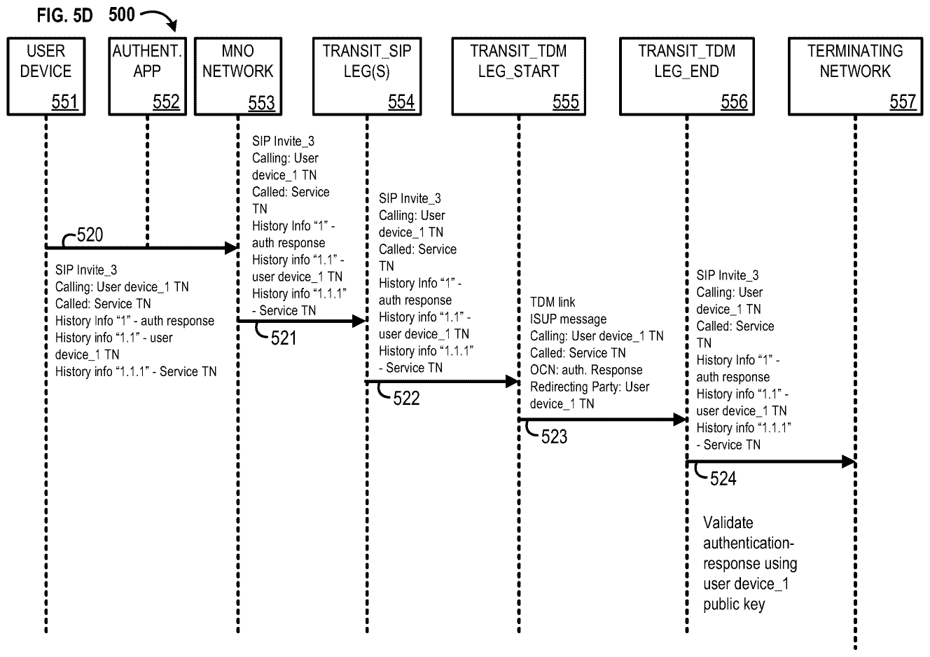

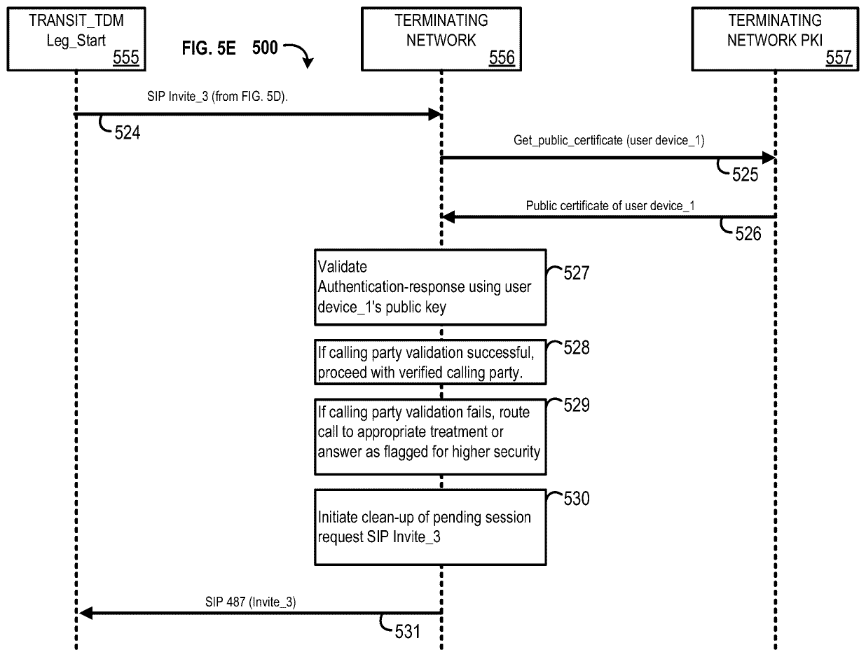

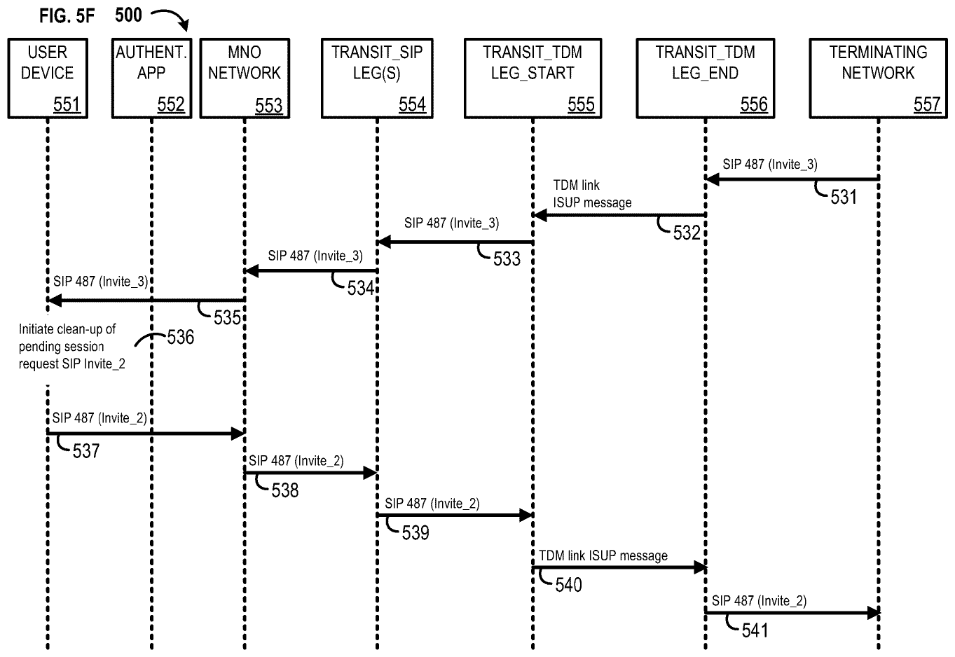

If the validation is unsuccessful (e.g., due to missing or compromised information), the system may initiate the authentication/verification processes described herein (e.g., by establishing an intermediary communication session with the originating user device as described in greater detail below with respect to FIGS. 5A-9).

After completing all verification steps, the session controller 320 may facilitate final authentication and service access. For example, the session controller 320 may send a session forwarding message to the service device 316. The session forwarding message may contain verified identity information, the validated session token, and any session policies, such as access control details or service limits. The service device 316 may then grant access to the calling device, confirming the service is available. This confirmation may be routed back to the calling device via the session controller 320.

The system 330 may be configured for session audit and logging. For example, the session controller 320 may log details of the session with the AS validation app 322 or AS STI_VS 321 for auditing purposes. Logged details may include session start and stop times, time between the various messages verification results, and any anomalies flagged during the process, such as suspected fraud attempts, network errors or potentially illegitimate or compromised messages.

Throughout this process, various message types may be used, including SIP messages such as SIP INVITE, 180 Ringing, 200 OK, and BYE, HTTP/HTTPS requests for RESTful API communication, JSON payloads for structured data exchange, cryptographic tokens such as X.509 certificates, JWTs, or STIR/SHAKEN identity headers, and error responses such as SIP 403 Forbidden or 401 Unauthorized.

FIG. 3C shows an example system 340. Similar to the system 330, the system 340 may comprise the service network 315, a session controller 320, the service device 316, an application server (“AS”) secure telephony identity and verification service (STI_VS) 321, an AS validation application 322, and an AS feature server 323. However, unlike the system 330, the devices of 340 may communicate in a more linear fashion. For example, based on receiving a session invite message (or other similar communication) originating from the originating user device, a transit device, or other device, the service network 315 may initiate communication with the AS STI_VS 321. This may include sending caller identity information, certificates, or a digital signature for verification. The AS STI_VS 321 may validate the caller's identity by cross-checking the data against a trusted database or performing cryptographic validation. If the identity is verified, the AS STI_VS 321 may pass the information to the AS validation app 322 for further validation.

At the AS validation app 322, additional checks may be conducted. For example, the validation app 322 may verify session tokens, timestamps, or other security measures to ensure the integrity and authenticity of the request. If the token and other metadata pass the checks, the AS validation app 322 may provide confirmation and forward the session data toward the next step in the process.

If validation is successful, the system may enable features or services associated with the session through the AS feature server 323. The AS feature server 323 may handle specific feature activation requests, such as enabling particular functionalities or tailoring the session for the service device 316. The AS feature server 323 may then communicate directly with the service device 316 to activate these features or enable access based on the authenticated session.

If the validation is unsuccessful (e.g., due to missing or compromised information), the system may initiate the authentication/verification processes described herein (e.g., by establishing an intermediary communication session with the originating user device as described in greater detail below with respect to FIGS. 5A-9).

After successful validation (whether based on the initial message or the subsequent validation process as described in greater detail below), the service device 316 may grant access to the calling device once all verifications and validations are complete. The service device 316 may also provide feedback or acknowledgment to the other components in the system, such as the AS feature server 323, AS validation app 322, or service network 315.

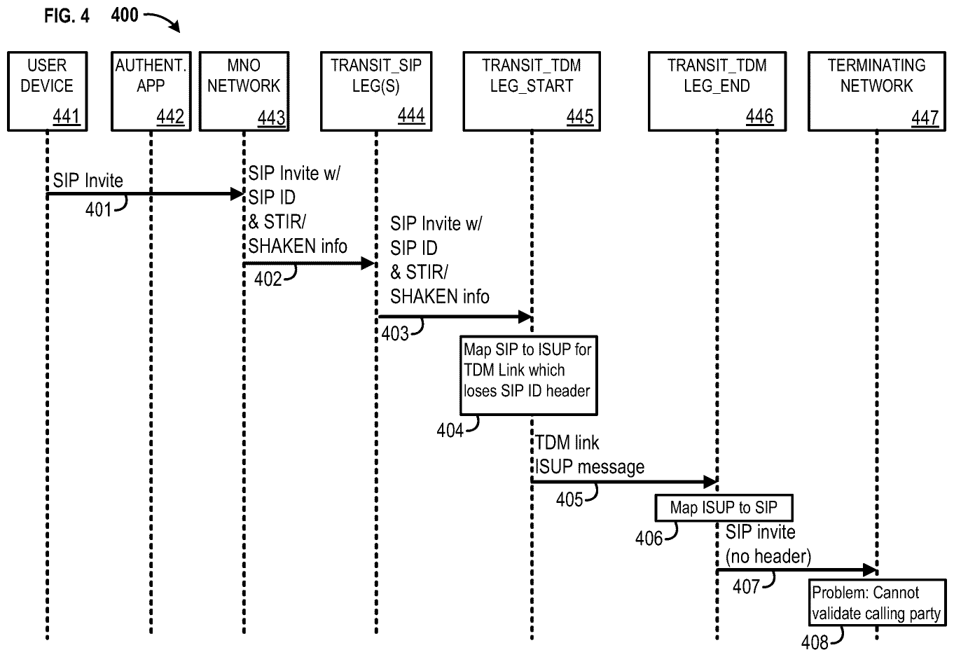

FIG. 4 shows a system and method 400. The system may comprise an originating user device. The originating user device may comprise, for example, a phone, a smart phone, a tablet, a computer, a smart device, or other similar device configured for communication. The originating user device may comprise or otherwise be associated with an authentication application. The authentication application may be configured to store, determine, generate, or otherwise process authentication, verification, and/or validation credentials associated with the originating user device. The system may comprise an originating network (MNO network). The originating network may be configured to process data. The system 400 may comprise one or more transit networks and/or one or more devices associated with the one or more transit networks. For example, the one or more transit networks may comprise one or more SIP legs, one or more TDM legs, combinations thereof, and the like. The system 400 may comprise a terminating network and/or one or more devices associated with the terminating network.

At 401, the originating user device may send a first session invite message. The originating user device may comprise for example, a phone, a smart phone, a laptop, a computer, a tablet, a set-top-box, or other similar user device. The originating user device may be associated with an originating network. The originating network may be associated with (e.g., owned by/operated by, or otherwise controlled by) a first mobile network operator (MNO). The first session invite message may comprise one or more identifier associated with the originating user device. For example, the first session invite message may comprise a calling telephone number (calling TN). The first session invite message may comprise one or more identifiers associated with a recipient device. For example, the first session invite message may comprise a called telephone number (called TN).

For example, the first session invite message may comprise a session initiation protocol (SIP) invite. The SIP invite may comprise one or more request lines, one or more headers, data associated with the one or more headers, and one or more message bodies. The one or more request lines may comprise the SIP method, one or more request URIs, and a version indicator. For example, the request line may comprise an INVITE method that signals the nature of the request, followed by a URI such as sip: user@example. com to indicate the address of the recipient, and ends with SIP/2.0 to show the protocol version. For example, the one or more headers may comprise a “to” header indicating the recipient of the call (To: <sip:username@domain.com>). The headers may also include a “from” header, which, for example, may comprise from: <sip:caller@domain. com>; tag=123456 to specify the sender's information. The first session invite message may comprise authentication/verification information. For example, the first session invite message may comprise one or more identifiers and/or STIR/SHAKEN information. For example, the first session invite message may comprise one or more identity headers, which may comprise one or more tokens (e.g., a digitally signed token known as a “PASSporT” (Personal Assertion Token)). The one or more tokens may be signed by a trusted authority such as a service provider. The one or more tokens may encapsulate call data, such as the caller's ID, the destination number, a timestamp (e.g., to prevent replay attacks), one or more unique transaction identifiers, and/or signature data (e.g., to verify the call's source), combinations thereof, and the like.

The PASSporT token may comprise an attestation level to describe the relationship between the service provider and the caller. The attestation levels may range from “Full Attestation” (A-level), indicating that the service provider has authenticated the caller and can verify the number being used, to “Partial Attestation” (B-level), which implies the provider knows the customer but not the specific number, and “Gateway Attestation” (C-level), indicating that the call is being passed from an external source without knowledge of the caller's identity. To validate the digital signature, a receiving entity may use a public certificate associated with the signing authority. A device associated with the originating network (e.g., MNO Network 443) may receive the first session invite message.

At 402, the device in the originating network (e.g., MNO Network 443) may send the first session invitation message towards an intended recipient device (e.g., a computing device associated with a terminating network 447). The first session invite message may transit one or more transit networks and/or one or more devices associated therewith. For example, the one or more transit networks may comprise one or more SIP legs and/or one or more TDM legs, combinations thereof, and the like.

At 403, one or more transit network devices may send the first session invite to one or more other devices associated with the one or more transit networks. For example, a first transit network device of the one or more transit network devices may be configured for SIP and may send the first session invite message to a second transit network device configured for TDM. The TDM device may convert the first session invite message to another form or protocol. For example, the TDM device may receive the SIP message and convert it to an ISUP message. During the conversion, information in the first session invite message may be lost. For example, one or more identifiers and/or the authentication/verification may be lost.

The information may be lost, for example, because, at 404, for example, the TDM device may map information in the SIP message to one or more ISUP fields and the mapping may be imperfect. For example, during conversion, the one or more identifiers and/or authentication/verification information may be lost or altered. For example, the SIP ID may be lost.

At 405, the one or more transit network devices may send the converted first session invite message towards the terminating network. Before reaching the terminating network, the converted first session invite message may transit one or more other transit network devices (e.g., a TDM leg end device 446). At 406, in the process of converting the first session invite message again, the one or more other transit network devices may map information in the ISUP to one or more SIP data fields. However, because information was lost during conversion from SIP to ISUP, the SIP may be missing information when it reaches the terminating network.

At 407, the first session invite message may be sent to the terminating network (and/or one or more devices associated therewith.

At 408, the one or more devices in the terminating network that receive the first session invite message may determine that information is missing. For example, as a result of the missing information, the one or more devices associated with the terminating network that receive the first session invite message may be unable to validate the calling party (e.g., the originating user device). The present methods and systems address this problem as discussed in greater detail below.

FIGS. 5A-5F shows an example system and method 500. The example system and method 500 may be carried out via any one or more devices described herein. For example, the system 500 may comprise an originating user device. The originating user device may comprise, for example, a phone, a smart phone, a tablet, a computer, a smart device, or other similar device configured for communication. The originating user device may comprise or otherwise be associated with an authentication application. The authentication application may be configured to store, determine, generate, or otherwise process authentication, verification, and/or validation credentials associated with the originating user device. The system 500 may comprise an originating network (MNO network). The originating network may be configured to process data. The system 500 may comprise one or more transit networks and/or one or more devices associated with the one or more transit networks. For example, the one or more transit networks may comprise one or more SIP legs, one or more TDM legs, combinations thereof, and the like. The system 500 may comprise a terminating network and/or one or more devices associated with the terminating network.

For example, at 501, an originating user device may send a first session invite message. The originating user device may comprise for example, a phone, a smart phone, a laptop, a computer, a tablet, a set-top-box, or other similar user device. The originating user device may be associated with an originating network. The originating network may be associated with (e.g., owned by/operated by, or otherwise controlled by) a first mobile network operator (MNO). The first session invite message may comprise one or more identifier associated with the originating user device. For example, the first session invite message may comprise a calling telephone number (calling TN). The first session invite message may comprise one or more identifiers associated with a recipient device. For example, the first session invite message may comprise a called telephone number (called TN).

For example, the first session invite message may comprise a session initiation protocol (SIP) invite. The SIP invite may comprise one or more request lines, one or more headers, data associated with the one or more headers, and one or more message bodies. The one or more request lines may comprise the SIP method, one or more request URIs, and a version indicator. For example, the request line may comprise an INVITE method that signals the nature of the request, followed by a URI such as sip:user@example. com to indicate the address of the recipient, and ends with SIP/2.0 to show the protocol version. For example, the one or more headers may comprise a “to” header indicating the recipient of the call (To: <sip:username@domain.com>). The headers may also include a “from” header, which, for example, may comprise from: <sip:caller@domain. com>; tag=123456 to specify the sender's information.

At 502, the originating MNO (and/or device associated therewith) may add an SIP ID (e.g., a Call-ID header). The SIP ID may comprise, for example, a unique identifier like Call-ID: abcdef123456@domain. com, which correlates the session (e.g., an SIP ID). A CSeq header may comprise, for example, a sequence number (CSeq: 1 INVITE) used for matching requests and responses. Also at 502, a public key infrastructure associated with the originating network MNO (e.g., a MNO PKI) may store a public certificate associated with the terminating network. The public certificate associated with the terminating network may be linked to a domain associated with the terminating network and may contain the public key associated with the terminating network. The originating user device may supply a call-id header. The originating MNO may modify the call-id header (in which case it maintains a mapping so that it talks to the device about one call-id and talks to the downstream network as a second call-id).

At 503, the first session invite message may transit one or more transit networks (e.g., the transit legs). The one or more transit networks may not be owned or operated or otherwise controlled by the MNO associated with the originating network. The one or more transit networks and devices associated therewith may be configured for one or more communication protocols. For example, the one or more transit networks may be configured for time-division-multiplexing (TDM). For example, the one or more transit networks may, for various reasons, be configured to convert an SIP message to an ISND User Part message. Converting an SIP message to an ISUP message enables communication between modern VoIP networks and traditional circuit-switched PSTN networks. The conversion may occur at one or more media gateway controllers (MGCs) or one or more signaling gateways, which act as intermediaries between two types of networks (e.g., two networks configured for different communication protocols). For example, when an SIP INVITE message is received, signaling the initiation of a call, it may be translated to an ISUP Initial Address Message (IAM) to set up the call in a Public Switched Telephone Network (PSTN).

Thus, at 504, a device in the one or more transit networks may parse the SIP invite to extract relevant information (e.g., “from” and “to” headers) which may correspond to the calling TN and called TN. For example, a SIP header like from: <sip: caller@domain. com>is mapped to the Calling Party Number in the ISUP IAM. The SIP Call-ID, a unique identifier for tracking the session, is mapped to a corresponding transaction ID in ISUP for consistency and call correlation. For example, the body of the SIP message, often containing Session Description Protocol (SDP) data, may be translated to one or more ISUP parameters that describe media attributes. For example, SDP lines detailing audio codecs and media ports, such as audio 5004 RTP/AVP 0, are converted into ISUP Bearer Capability Information Elements that indicate the type of service being requested. The SIP CSeq header, which ensures the correct order of SIP transactions, helps manage the sequence of messages during conversion.

During the conversion from SIP to ISUP (which is merely exemplary and explanatory and not intended to be limiting) information may be lost or altered. For example, during the conversion from SIP to ISUP, IDs and authentication/verification information may be affected due to differences in how the two protocols handle session identification and security. For example, SIP uses headers such as Call-ID, From, To, and CSeq to uniquely identify and manage calls, while also supporting mechanisms for user authentication and verification, such as Authorization headers and secure authentication protocols like Digest Authentication. ISUP, on the other hand, does not have built-in support for authentication and verification as in SIP. Because ISUP is largely concerned circuit-switched call setup (and thus does not need end-to-end user authentication information since it relies on the trusted and controlled environment of the PSTN), information associated with end user authentication and verification may be lost. Thus, when converting a SIP message to an ISUP message, detailed authentication headers and security tokens present in SIP may be lost or altered or not transferred. Any IDs such as Call-ID in SIP may be mapped to simpler transaction identifiers or call reference numbers in ISUP, but these simple transaction identifiers and call reference numbers do not carry the same user-specific or cryptographic authentication attributes.

At 505, the first session invite message may be converted again. For example, a transit TDM leg end device may receive the ISUP message and convert it back to SIP. However, due to the loss of information when the first session invite message was converted, for example, from SIP to ISUP, when the first session invite message is converted back to SIP, information may still be absent. For example, the SIP message may not comprise an SIP ID and/or authentication/verification information associated with the originating user device. Additionally/alternatively, a public key infrastructure associated with the terminating network may store the public certificate associated with the originating user device. The public certificate associated with the originating user device may be associated with (e.g., “linked to”) a domain associated with the MNO of the originating network. The public certificate may comprise the public key associated with the originating user device. Additionally/alternatively, at 505, the SIP message may be sent to one or more devices in the one or more transit networks. Additionally/alternatively, at 505, it may be determined that the SIP invite has no ID header and/or that the ID header has been altered and/or that the SIP invite is missing authentication/verification information. For example, an application server (STI_VS) may determine that the SIP Invite has no Identity header or that the header is invalid, etc. Additionally/alternatively, at 505, a nonce may be generated and/or retrieved. Additionally/alternatively, at 505, a second session invite message may be generated. The second session invite message may be a validation call. The second session invite message may be configured to establish an intermediary (e.g., temporary) communication channel for the purpose of authenticating/verifying the originating user device. The nonce value may be configured for an authentication challenge request.

The nonce may be generated by a cryptographically secure nonce generator. For example, the nonce may comprise 10 digits (e.g., “7392851460”). The second session invite message may comprise an authentication challenge. The second session invite message may comprise the nonce. The nonce may be inserted into the second session invite message as a calling number.

At 506 (as shown in FIG. 5B), the second session invite message may be sent. The second session invite message may comprise a second SIP invite. The second session invite message may be sent by a device in the terminating network. For example, the second session invite message may be sent by a STIR/SHAKEN device in the terminating network. Additionally/alternatively, the second session invite message may be sent by another device in the terminating network (e.g., a device associated with a service in the terminating network, a recipient user device in the terminating network). The second session invite message may comprise the nonce value and/or a public key. The second session invite message may comprise one or more identifiers associated with the originating user device (e.g., the calling device) and/or one or more identifiers associated with the recipient device/service (e.g., the called device). The nonce may be inserted into the calling ID header.

At 507, the second session invite message may be sent one or more transit networks and/or devices associated therewith. Continuing the above example, the second session invite message may, upon departing the terminating network, comprise an SIP invite and, while transiting the one or more transit networks or devices, may be converted to an ISUP message. Again, during conversion from, for example, SIP to ISUP, information in the second session invitation message may be lost or altered. The ISUP message, however, may maintain the calling ID (e.g., the nonce) and the called ID (e.g., the one or more identifiers associated with the originating user device).

At 508, the second session invite message may transit the one or more transit networks and/or device associated therewith. At 508, the second session invite message may be converted. For example, it may be converted from ISUP back to SIP. Upon conversion, the SIP may maintain the nonce in the calling field and the one or more identifiers associated with the originating user device in the called field.

At 509, the second session invite message may enter the originating network via one or more devices associated with therewith. For example, a network gateway device may receive the second session invite message.

The network gateway device associated with the originating network may prepare data to be signed. The data to be signed may include the received nonce, an original calling number (e.g., from the first session invite message), an original called number (e.g., from the first session invite message), a timestamp (e.g., a current timestamp), combinations thereof, and the like. An example may be: “7392851460|14085551234|18005551000|1635724800.”

A network device in the originating network and/or the originating user device may sign the authentication challenge. As example of a signed authentication challenge may be: “signature=RSA_Sign(private_key_A, SHA256(prepared_data)).” The network device in the originating network and/or the originating user device may be configured to signature truncation and conversion. For example, the originating network device and/or the originating user device may be configured to determine a hash (e.g., SHA-256 hash) of the full signature (e.g., hash=SHA256(signature)). For example, the originating network device and/or the originating user device may be configured to convert the hash to a larger integer (e.g., large_int =int. from_bytes(hash, ‘big’)). For example, the originating network device and/or the originating user device may be configured to determine the last 10 digits (e.g., truncated_sig=str(large_int) [−10:]). An exemplary truncated signature might be “6194872305.”

At 510, the second session invite message may be sent to (and/or received by) the originating user device.

FIG. 5C shows an exemplary system and method configured to authenticate the originating user device. For example, at 511, based on receipt of the second session invite message, the originating user device may associate (e.g., match) the second session invite message with the first session invite message (e.g., the pending session invite message).

Optionally, at 512, as the initially requested session (e.g., the session requested in the first session invite message) is pending (e.g., not yet stable), the nonce value may be sent to an authentication application on the originating user device (e.g., at 515). For example, the nonce may be sent to the authentication application. The authentication application may receive the nonce. The authentication application may send (e.g., at 516), based on receipt of the nonce, the nonce to a public key infrastructure (PKI) associated with the originating network. At 517, the PKI associated with the originating network may send, to the authentication application, a private key associated with the originating user device. At 518, the authentication application may provide the private key associated with the originating user device to the originating user device as an authentication response.

At 519, a third session invite message. For example, the originating user device or another device associated with the originating network may generated the third session invite message. The third session invite message may be generated based on receipt of the authentication response from the authentication application. The third session invite message may comprise the one or more identifiers associated with the originating user device (e.g., a calling TN), an SIP ID (e.g., “SIP Invite_3”), one or more identifiers associated with the recipient device (e.g., a called TN), and session history information (e.g., call history information). For example, the call history information may comprise one or more headers or fields such as a “history-info 1,” “history-info 1.1,” “history-info 1.1.1,” combinations thereof, and the like. For example, the history-info 1 may be populated with the authentication response, history-info 1.1 may be populated with an identifier associated with the originating user device, and history-info 1.1.1 may be populated with an identifier associated with the recipient device. The third session invite message may comprise the truncated signature. For example, the truncated signature may be inserted into a calling number field or header.

Optionally, at 513, it may be determined the initially requested session is stable. If that is the case, a “busy” or “call waiting” response (e.g., an SIP 486) may be sent.

Optionally, at 514, it may be determined that the initially requested session is not found. If that is the case, a “not found” message (e.g., an SIP 404) may be sent.

As shown in FIG. 5D, at 520, the third session invite message may be sent. For example, the originating user device may send the third session invite message out to the originating network. At 521, the originating network may send the third session invite message to one or more transit networks and/or one or more devices associated therewith. For example, at 521, a transit SIP device may receive the third session invite message and, at 522, send the third session invite message to a transit TDM device. At 523, the transit TDM device may convert the third session invite message from a first protocol (e.g., SIP) to a second protocol (e.g., ISUP). For example, the ISUP message may comprise a calling field populated with the identifier associated with the originating user device, a called field associated with the identifier associated with the recipient device or service (e.g., the device or service intended to receive the first session invite message). For example, the ISUP message may comprise an original called number (OCN) field. The OCN field may comprise the authentication response. For example, the ISUP message may comprise a redirecting party field. The redirecting party field may be populated with the identifier associated with the originating user device.

At 524, the third session invite message may be converted again (e.g., from ISUP to SIP). The third session invite message may be sent by the one or more transit devices to one or more terminating network devices. The third session invite message may comprise one or more identifiers associated with the originating user device, one or more identifiers associated with the recipient device or service, and calling history information. For example, a history-info header may be inserted into the third session invite message (e.g., SIP invite 3). It may be sent in the SIP message through the one or more transit carriers. If a conversion from SIP to ISUP is needed, it follows a conversion standard (e.g., 3GPP).

A device in the terminating network may receive the third session invite message. At 524, the authentication response (which may be included in the calling history information) may be validated using the public key associated with the originating user device. The public key may be preserved in a carrier's PKI store (e.g., each carrier may be configured with a PKI store as part of its infrastructure). For example the device in the terminating network (e.g., the application server) may be configured to reconstruct original signed data. For example, the device in the terminating network may be configured to determine the original nonce sent out of the terminating network (e.g., “7392851460”), the original calling number, the original called number, and a timestamp (e.g., an approximate timestamp configured to allow for network transit time etc . . . ). For example, the device in the terminating network may be configured to determine whether the timestamp associated with the third session invite was received/generated/determined within some amount of time associated with a timestamp associated with either or both of the first session invite message and/or the second session invite message. For example, it may be determined that a validation has failed if the timestamp exceeds a certain value (e.g., elapsed time). If the timestamp exceeds the value, the message may be flagged as suspicious (e.g., potentially tampered with).

As shown in FIG. 5E, at 525, a device in the terminating network that receives the third session invite message (e.g., at 524), may query a public key infrastructure associated with the terminating network to determine a public certificate associated with the originating user device. The device in the terminating network may be configured to signature verification. For example, the device in the terminating network may use a public key associated with the originating network to verify the signature.

At 526, the PKI associated with the terminating network may send, to the device in the terminating network that requested it, the public certificate associated with the originating user device.

At 527 a device in the terminating network may validate the authentication response received from the originating user device. This may be done by either an authentication/verification server and/or an application server. The device in the terminating network may validate the authentication response received from the originating user device based on the public key associated with the originating user device received from the PKI associated with the terminating network. For example, the device in the terminating network may be configured to generate the full signature using the reconstructed data (e.g., “expected_signature=RSA_Sign(public_key_A, SHA256(reconstructed_data).” For example, the device in the terminating network may be configured to apply a same truncation process to the expected signature. This may include determining a hash of the expected signature (e.g., SHA-256 hash), converting the hash to a larger integer, and determining the last 10 digits of the larger integer. The resulting 10 digit nonce may be compared with the received truncated signature. If the generated truncated signature matches the received truncated signature, the call may be validated.

At 528, if the validation is successful, the initially requested call (e.g., the communication session intended to be established by the first session invite message) may be established and the calling party (e.g., the originating user device and intended recipient user device) may proceed with a validated communication session.

Optionally, at 529, if the calling party validation fails, the call may be routed to another device for appropriate treatment. For example, the call may be flagged and routed to a special security device (e.g., an announcement or high-suspicion call-handling process).

At 530, in the case of a successful validation, a clean-up protocol may be initiated. The clean-up protocol may be configured to clean-up the intermediary communication sessions (e.g., sessions associated with one or more of the second session invite message and/or the third session invite message).

As shown in FIG. 5F, at 531, a first session termination message may be sent. The first session termination message may be sent, for example, by the device in the terminating network that received the third session invite message. The first session terminating message may be configured to terminate (e.g., tear-down) the intermediary communication session that was used to authenticate/validate the originating user device. For example, the first session termination message may comprise an SIP message. For example, the first session termination message may comprise an SIP 487 message. The SIP 487 message (e.g., a “response code” or “request terminated” message) may be configured to indicate that a SIP request, often an INVITE intended to establish a call, has been terminated and/or canceled before it was fully processed. The first session termination message may be configured to confirm to the sender that the previous request was terminated due to a termination or cancel request or some other condition causing termination. The recipient of an invite message can send an SIP 487 to terminate the request (e.g., as opposed to “cancelling” the request, which may be done by the originator). For example, when a client sends an invite to initiate a call but then decides to cancel it—such as when a user hangs up while the call is still ringing—a cancel message may be sent to the server handling the request. Additionally/alternatively, upon receiving an invite, a device may respond to the invite with a 487 “Request Terminated” to acknowledge that the call setup process was stopped.

At 532, upon receiving the first session termination message, one or more devices in the one or more transit networks may convert the first session termination from a first form to a second form. For example, if the first session termination message is sent by the device in the terminating network as an SIP message, the one or more devices in the one or more transit networks may convert the first termination message to an ISUP message. During transit, the first session termination message may be converted to one or more other forms (including back to an SIP message).

At 533, the first termination message (either as an SIP message and/or as an ISUP message) may be sent to one or more other devise in the one or more transit networks. At 534, the first session termination message may be sent to the originating network (and/or one or more devices associated therewith). At 535, the first session termination message may be sent to the originating user device.

At 536, the originating user device may initiate clean-up of the second session invitation message. For example, at 537, the originating user device may send a second session termination message. The originating user device may send the second session termination message to (e.g., towards) the computing device in the terminating network. The second session termination message may comprise, for example, a second SIP 487. The second SIP 487 may be associated with the second session invite message. The second session termination message may, in route to the terminating network, transit one or more transit networks and/or devices associated therewith. For example, at 538 the second session termination message may leave the originating network and enter the one or more transit networks (e.g., be received by one or more devices associated with the one or more transit networks). At 539, the second session termination message may continue to transit the one or more transit networks and may be received, for example, by a TDM device and converted, for example, from SIP to ISUP. At 540, the second session termination message may be sent to another device in the one or more transit networks (e.g., a device associated with the end of a TDM leg of the one or more transit networks). At 541, the second session termination message may be sent to (and received by) a device in the terminating network and the intermediary communication session may be terminated.

The present disclosure relates to systems and methods for authenticating devices and communication sessions in network environments where authentication information may be lost or altered during transmission. The disclosed methods and systems provides a technical solution to the technical problem of verifying the identity of originating devices when traditional authentication mechanisms fail due to network infrastructure limitations, transmission errors, protocol conversions, combinations thereof, and the like. Traditional caller identification and verification methods often rely on information contained within the initial call setup messages. However, as calls pass through intermediate networks, critical authentication data is lost or modified due to protocol conversions, network address translations, or differing security policies among carriers. This erosion of verification data leaves terminating networks and call recipients vulnerable to spoofing, fraud, and other malicious activities.

Existing solutions have attempted to address this issue through end-to-end encryption or by implementing complex authentication protocols across all network segments. However, these approaches face significant hurdles in terms of widespread adoption, interoperability between diverse network types, and performance impacts on call setup times.

The communication management system described herein improves the functioning of computing devices involved in establishing secure communication sessions. By implementing an intermediate authentication process, the system enhances the security and reliability of communications across diverse network architectures. This improvement allows devices to overcome limitations in existing network protocols and infrastructure that can result in the loss of critical authentication data.

The disclosed methods and systems may detect missing authentication information in an initial session invite message. The disclosed methods and systems may then establish a temporary communication channel to securely exchange authentication data with the originating device. This process enables the system to verify the identity of the originating device even when standard authentication mechanisms fail or are otherwise compromised during transmission through various network segments.

The methods and systems described herein may enhance the capabilities of network devices by providing a robust authentication mechanism that is resilient to data loss or alteration. This technical improvement increases the overall security and reliability of communication systems, particularly in scenarios involving multiple network types or protocol translations.

The methods and systems disclosed herein provide significant technical improvements to the functioning of computing devices involved in establishing secure communication sessions across diverse network architectures. By implementing an intermediate authentication process, the system enhances the security and reliability of communications, particularly in scenarios where traditional authentication mechanisms may fail due to network infrastructure limitations or protocol conversions.

The disclosed techniques allow devices to overcome limitations in existing network protocols and infrastructure that can result in the loss of critical authentication data during transmission. The system may detect missing authentication information in an initial session invite message and establish a temporary communication channel to securely exchange authentication data with the originating device. This process enables the system to verify the identity of the originating device even when standard authentication mechanisms are compromised during transmission through various network segments.

The technical improvements realized by the disclosed methods include, for example, enhanced authentication resilience by providing a robust authentication mechanism that is resilient to data loss or alteration during transmission across multiple network types or protocol translations. This improves the overall security and reliability of communication systems.

The technical improvements realized by the disclosed methods include, for example, improved interoperability by implementing an intermediate authentication process, the system enables secure communications between devices operating on different network types or using incompatible protocols. This enhances interoperability across diverse network architectures. The technical improvements realized by the disclosed methods include, for example, dynamic adaptation to network conditions by dynamically detecting missing authentication information and initiating appropriate verification processes. This allows for real-time adaptation to varying network conditions and ensures consistent security across different communication environments. The technical improvements realized by the disclosed methods include, for example, reduced vulnerability to man-in-the-middle attacks, by the use of public key cryptography and nonce values in the authentication process significantly reduces the risk of man-in-the-middle attacks, even when initial authentication data is compromised. The technical improvements realized by the disclosed methods include, for example, enhanced call security, for voice and video communication systems, the improved authentication process reduces the risk of fraudulent or spoofed calls, enhancing the overall security and trustworthiness of the communication platform. The technical improvements realized by the disclosed methods include, for example, efficient use of network resources by establishing temporary authentication channels only when necessary, the system optimizes the use of network resources while maintaining a high level of security. These technical improvements individually, and/or collectively enhance the capabilities of network devices by providing a more robust, flexible, and secure authentication mechanism for establishing communication sessions. The disclosed methods and systems address critical security challenges in modern communication networks, particularly in scenarios involving multiple network types, protocol translations, or potential data loss during transmission.

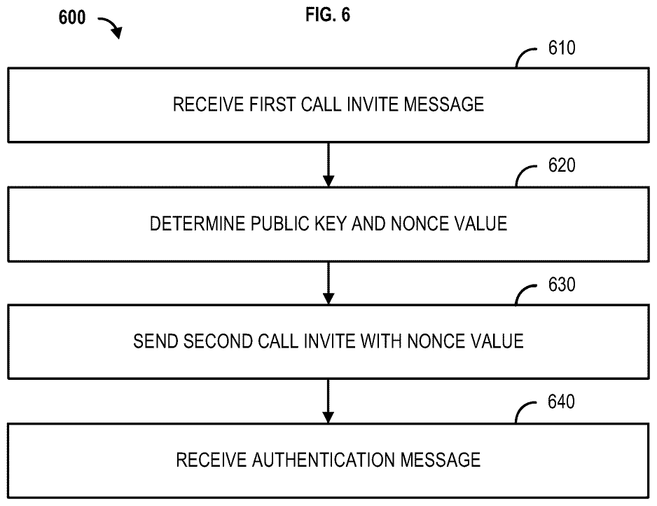

FIG. 6 shows an example method 600. The method 600 may be carried out via any one or more of the devices described herein. At 610, a first session invite message may be received. For example, the first session initiation message may be received by a computing device. The computing device may comprise one or more of an authentication/verification device such as a STIR/SHAKEN server or a service device (e.g., an interactive voice response or other service). The first session invite message may be associated with (e.g., originate from) an originating user device. The computing device may be associated with one or more transit networks and/or one or more terminating networks. The originating user device may be associated with an originating network. The session initiation message may comprise one or more identifiers, one or more headers, and/or data therein. For example, the session initiation message may comprise one or more of an identifier associated with the originating user device (e.g., caller TN), an identifier associated with a recipient device (e.g., a service associated with a terminating network, a recipient user device). The first session invite message may be placed by the originating user device in the originating network and may transit one or more transit networks. The one or more transit networks may or may not be owned or controlled by a service provider associated with the originating network (e.g., a mobile network operator or “MNO”) and/or a service provider associated with the terminating network. The first session initiation message may comprise a session identifier. As the first session initiation message transits the one or more transit networks, information in the first session initiation message may be lost or changed. The first session invite message may comprise a session initiation protocol (SIP) invite configured for caller verification.

At 620, a public key and/or a nonce value may be determined. The public key may be one part of a cryptographic key pair used in public-key cryptography. The public key may be configured for encrypting data or verifying digital signatures. The public key may comprise or otherwise be associated with a static value that is associated with an entity. The nonce value may comprise a unique, random, or pseudo-random value generated for one-time use. The nonce value may be configured to ensure that certain actions, like cryptographic operations, are unique and cannot be reused or replayed. The public key and the nonce value may be determined based on determining that the first session invite message is missing information. For example, the first session invite message may be missing one or more identifiers and/or authentication/verification information. Determining the public key and/or the nonce value may comprise querying one or more other devices (e.g., a public key generator device and/or a nonce value generator device) and/or databases to retrieve the public key and/or the nonce value. Additionally and/or alternatively, the public key and the nonce value may be stored on and/or generated by the computing device that received the first session invitation message.

At 630, a second session invite message may be sent. The second session invite message may be sent by the computing device. The second session invite message may be sent to the originating user device. The second session initiation message may comprise the public key, the nonce value, one or more identifiers (e.g., calling TN, called TN), metadata, rich call data (RCD), or other data. The second initiation message may be transit the one or more transit networks. Sending the second session invite message may comprise establishing an intermediate communication session between the computing device and the originating user device (e.g., the second session invite may be configured to establish the intermediate communication session). The intermediate communication session may be a temporary communication session. The intermediate communication session may be established in order to determine additional and/or missing authentication information and/or one or more identifiers associated with the originating user device. The intermediate communication session may be facilitated by a system comprising one or more originating network devices, one or more transit network devices, and/or one or more terminating network devices.

At 640, an authentication message may be received. The authentication message may be received by the computing device. The authentication message may be associated with (e.g., sent by) the originating user device and/or one or more other devices associated with the originating network and/or one or more devices associated with the one or more transit networks. The authentication message may be sent by the originating user device based on the originating user device's receipt of the second session invitation message.

The method may comprise determining the first session invite message is missing information. For example, the method may comprise determining the first session invite message is missing authentication/verification information. For example, the method may comprise determining the first session invite message is missing one or more identifiers or other information. The method may comprise receiving the missing information. The method may comprise terminating, based on receiving the authentication message, the intermediate communication session. The method may comprise verifying, based on the authentication message associated with the public key, the originating user device. The method may comprise sending, based on the authentication message, to a recipient user device, the first session invite message.

The method may comprise receiving, by a computing device, from an originating user device, a first session invite message. The method may comprise determining the first session invite message is missing authentication information associated with the originating user device. The method may comprise establishing, based on determining the first session invite message is missing authentication information, an intermediate communication session. The method may comprise sending, to the originating user device, via the intermediate communication session, a public key. The method may comprise receiving, based on the public key, from the originating user device, via the intermediate communication session, authentication information. The method may comprise authenticating, based on the authentication information, the originating user device. The method may comprise based on authenticating the originating user device, terminating the intermediate communication session.

The method may comprise receiving, by a computing device, from an originating user device, a first session invite message requesting an initial communication session, wherein the first session invite message comprises an identifier associated with the originating user device and an identifier associated with a recipient user device. The method may comprise determining the first session invite message is missing authentication information. The method may comprise based on determining the first session invite message is missing authentication information, and based on the identifier associated with the originating user device, retrieving a public key. The method may comprise establishing, between the computing device and the originating user device, an intermediate communication session. The method may comprise sending, via the intermediate communication session, to the originating user device, the public key and a request for the missing authentication information. The method may comprise receiving, the from the originating user device, via the intermediate communication session, authentication information. The method may comprise based on receiving the authentication information, terminating the intermediate communication session. The method may comprise establishing, based on receiving the missing authentication information and based on the identifier associated with the recipient user device, the initial communication session between the originating user device and the recipient user device.

The method may comprise receiving, by an originating user device, a first session invite message comprising a public key. The method may comprise associating the first session invite message with a pending service call session. The method may comprise sending the public key to an authentication application on the originating user device. The method may comprise receiving, from the authentication application on the originating user device, a private key. The method may comprise generating, by the originating user device, based on the private key, a second session invite message. The method may comprise sending, to a network device associated with the originating user device, the second session invite message.

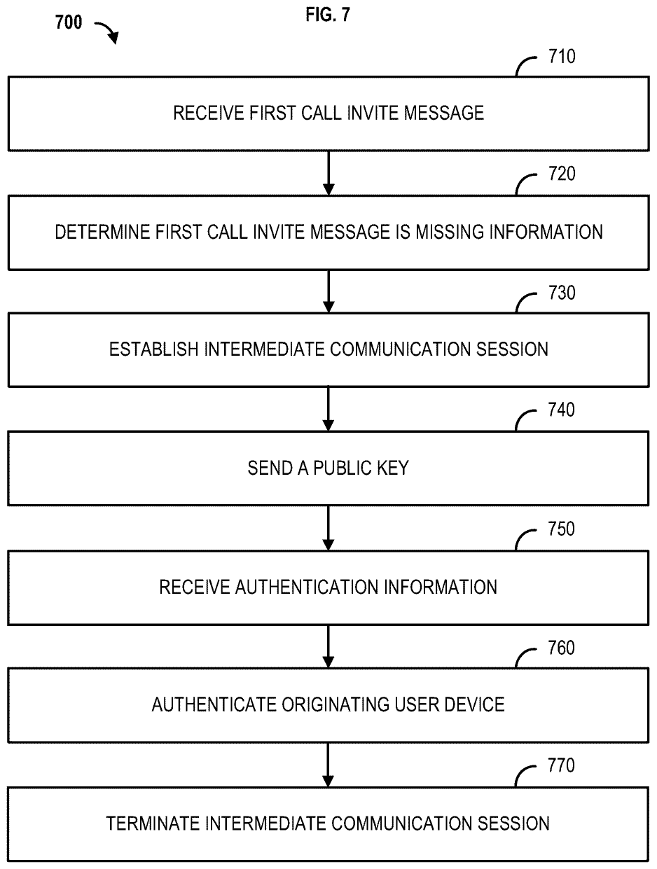

FIG. 7 shows an example method 700. The method 700 may be carried out via any one or more of the devices described herein. At 710, a first session invite message may be received. For example, the first session initiation message may be received by a computing device. The computing device may be associated with a terminating network. For example the computing device may comprise one or more of an authentication/verification device such as a STIR/SHAKEN server or a service device (e.g., an interactive voice response or other service). The first session invite message may be associated with (e.g., originate from) an originating user device. The computing device may be associated with one or more transit networks and/or one or more terminating networks. The originating user device may be associated with an originating network. The session initiation message may comprise one or more identifiers, one or more headers, and/or data therein. For example, the session initiation message may comprise one or more of an identifier associated with the originating user device (e.g., caller TN), an identifier associated with a recipient device (e.g., a service associated with a terminating network, a recipient user device). The first session invite message may be placed by the originating user device in the originating network and may transit one or more transit networks. The one or more transit networks may or may not be owned or controlled by a service provider associated with the originating network (e.g., a mobile network operator or “MNO”) and/or a service provider associated with the terminating network. The first session initiation message may comprise a session identifier. As the first session initiation message transits the one or more transit networks, information in the first session initiation message may be lost or changed. The first session invite message may comprise a session initiation protocol (SIP) invite configured for caller verification.

At 720, it may be determined the first session invite message is missing authentication information associated with the originating user device. For example, intermediate network nodes, such as routers, firewalls, or load balancers in the one or more transit networks and/or terminating network, may have varied configurations and protocols that strip or modify authentication information as the call passes between networks with differing policies or settings. For example, protocol translation is common when calls traverse networks using different signaling protocols or technologies, and network address translation (NAT) or other protocol translation issues between these networks can result in altered headers or removed authentication details. For example, each service provider may enforce unique security policies, including deep packet inspection (DPI), firewalls, or intrusion detection systems, which can modify or strip data elements that do not align with their standards or security requirements. For example, calls transiting through middleware or proxy servers managed by different service providers can experience interference with authentication data, as these systems often handle protocol mediation or load balancing, which could unintentionally modify or drop critical information.

At 730, an intermediate communication session may be established. The intermediate communication session may comprise a temporary communication session established between the computing device and the originating user device for the purpose of authenticating the originating user device. For example, based on determining the first session invite message is missing information, the computing device may send a second session initiation message to the originating user device. The second session initiation message may comprise, for example, a session initiation protocol (SIP) invite. The second session initiation message may comprise one or more of a public key and/or a nonce value.

The public key may be one part of a cryptographic key pair used in public-key cryptography. The public key may be configured for encrypting data or verifying digital signatures. The public key may comprise or otherwise be associated with a static value that is associated with an entity. The nonce value may comprise a unique, random, or pseudo-random value generated for one-time use. The nonce value may be configured to ensure that certain actions, like cryptographic operations, are unique and cannot be reused or replayed. The public key and the nonce value may be determined based on determining that the first session invite message is missing information. For example, the first session invite message may be missing one or more identifiers and/or authentication/verification information. Determining the public key and/or the nonce value may comprise querying one or more other devices (e.g., a public key generator device and/or a nonce value generator device) and/or databases to retrieve the public key and/or the nonce value. Additionally and/or alternatively, the public key and the nonce value may be stored on and/or generated by the computing device that received the first session invitation message.

The second session initiation message may comprise one or more of the public key, the nonce value, one or more identifiers (e.g., calling TN, called TN), metadata, rich call data (RCD), or other data. The second initiation message may be transit the one or more transit networks. Sending the second session invite message may comprise establishing an intermediate communication session between the computing device and the originating user device. The intermediate communication session may be a temporary communication session. The intermediate communication session may be facilitated by a system comprising one or more originating network devices, one or more transit network devices, and/or one or more terminating network devices.

At 740, the second session invite message may be sent by the computing device. The second session invite message may be sent to the originating user device. The second session initiation message may comprise the public key, the nonce value, one or more identifiers (e.g., calling TN, called TN), metadata, rich call data (RCD), or other data. The second initiation message may be transit the one or more transit networks.

At 750, authentication information may be received. For example, the authentication information may be received based on the public key. For example, the authentication information may be received by the computing device. For example, the authentication information may be received from the originating user device (and/or from one or more transit devices associated with the one or more transit networks). For example, the authentication information may be received via an authentication message. The authentication message may be received by the computing device. The authentication message may be associated with (e.g., sent by) the originating user device. The authentication message may be sent by the originating user device based on the originating user device's receipt of the second session invitation message. The authentication information may comprise an authentication response. The authentication message may comprise a third session initiation message. The third session initiation message may comprise one or more identifiers and/or historical call information. For example, the third session initiation message may comprise the authentication response (which may be generated by the originating user device based on an authentication protocol at the originating user device incorporating an authentication application on the originating user device).

The one or more identifiers may comprise, for example, a calling TN, a called TN, an SIP invite ID, and/or one or more other identifiers. The historical call information may comprise, for example one or more fields and/or one or more headers. For example, this historical call information may comprise the authentication response (e.g., a truncated signature as described above) in a first field or header, an identifier associated with the originating user device in a second header, and an identifier associated with the computing device in a third header.

At 760, the originating user device may be authenticated. Authenticating the originating user device may comprise retrieving, by the computing device, based on the information in the third session initiation message, a public certificate associated with the originating user device. For example, the computing device (in the terminating network) may query a public key infrastructure (PKI) system or device associated with the terminating network. Based on authenticating (e.g., validating) the originating user device, the initially requested communication session may be established. For example, a communication session between the calling party and the called party (e.g., the called service) may be established.

At 770, the intermediate communication session may be terminated. For example, the intermediate communication session may be terminated based on the authenticating the originating user device. Terminating the intermediate communication session may comprise sending a session termination message to the user device. The session termination message may transit one or more transit networks and/or transit devices associated therewith. For example, the session termination message may comprise an SIP message. For example, the session termination message may comprise an SIP 487 “request terminated” message. The session termination message may be associated with the third session initiation message sent by the user device to the computing device. Thus, the session termination message may terminate the intermediate communication session.

The method may comprise initiating one or more call clean-up protocols. For example, the computing device may initiate a first session clean-up protocol associated with any communication sessions initiated by the computing device. Similarly, the originating user device may initiate one or more session clean-up protocols associated with any communication sessions initiated by the originating user device. For example, the originating user device may send an SIP 487 to the computing device associated with the second session initiation message.

The method may comprise verifying the originating user device. The method may comprise sending, to a recipient user device the first session invite message.

The method may comprise receiving, by a computing device, a first session invite message associated with an originating user device. The method may comprise determining, based on the first session invite message, a public key and a nonce value. The method may comprise sending, to the originating user device, based on the public key, a second session invite message comprising the nonce value. The method may comprise receiving, from the originating user device, based on the second session invite message, an authentication message associated with the public key.

The method may comprise receiving, by a computing device, from an originating user device, a first session invite message requesting an initial communication session, wherein the first session invite message comprises an identifier associated with the originating user device and an identifier associated with a recipient user device. The method may comprise determining the first session invite message is missing authentication information. The method may comprise based on determining the first session invite message is missing authentication information, and based on the identifier associated with the originating user device, retrieving a public key. The Explanatory method may comprise establishing, between the computing device and the originating user device, an intermediate communication session. The method may comprise sending, via the intermediate communication session, to the originating user device, the public key and a request for the missing authentication information. The method may comprise receiving, the from the originating user device, via the intermediate communication session, authentication information. The method may comprise based on receiving the authentication information, terminating the intermediate communication session. The method may comprise establishing, based on receiving the missing authentication information and based on the identifier associated with the recipient user device, the initial communication session between the originating user device and the recipient user device.

The method may comprise receiving, by a computing device, from an originating user device, a first session invite message requesting an initial communication session, wherein the first session invite message comprises an identifier associated with the originating user device and an identifier associated with a recipient user device. The method may comprise determining the first session invite message is missing authentication information. The method may comprise based on determining the first session invite message is missing authentication information, and based on the identifier associated with the originating user device, retrieving a public key. The method may comprise establishing, between the computing device and the originating user device, an intermediate communication session. The method may comprise sending, via the intermediate communication session, to the originating user device, the public key and a request for the missing authentication information. The method may comprise receiving, the from the originating user device, via the intermediate communication session, authentication information. The method may comprise based on receiving the authentication information, terminating the intermediate communication session. The method may comprise establishing, based on receiving the missing authentication information and based on the identifier associated with the recipient user device, the initial communication session between the originating user device and the recipient user device.

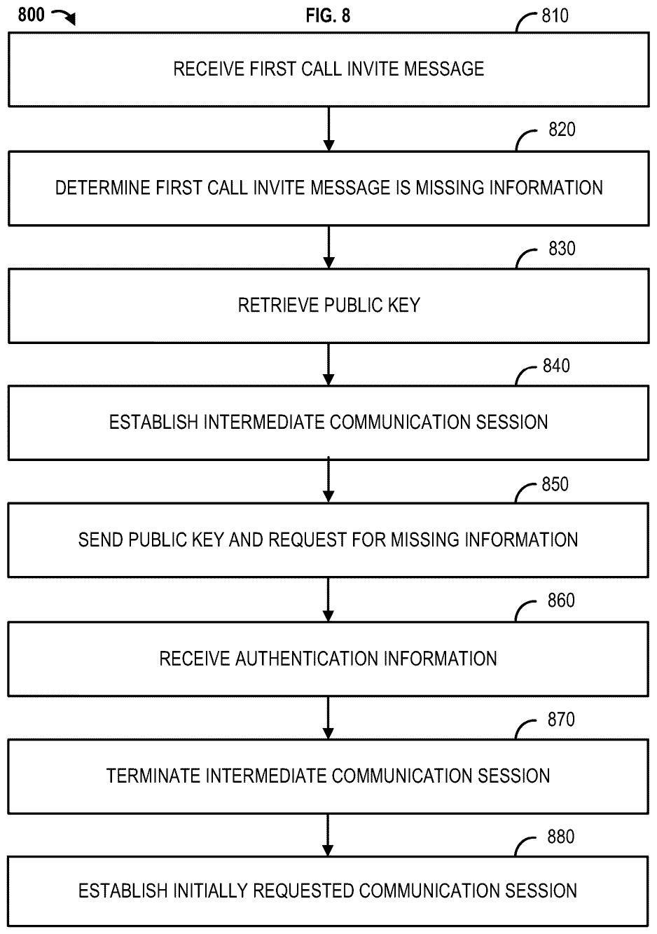

FIG. 8 shows an example method 800. The method 800 may be carried out via any one or more of the devices described herein. At 810, a first session invite message may be received. For example, the first session invite message may be received by a computing device. For example, the computing device may be associated with a terminating network. The first session invite message may comprise a request for an initial communication session. The first session invite message may be sent from an originating user device. The first session invite message may comprise one or more identifiers associated with the originating user device. The first session invite message may comprise one or more identifiers associated with an intended recipient device (e.g., an intended recipient service). For example, the first session invite message may comprise a calling TN and a called TN. When the first session invite message is sent from the originating user device, the first session invite message may comprise authentication/verification information. However, as the first session invite message transits one or more transit networks (and/or one or more transit devices associated therewith), the one or more identifiers and/or the authentication/verification information may be lost or altered.

At 820, the computing device may determine the first session invite message is missing information. For example, the first session invite message, when sent from the originating user device, may comprise one or more identifier and/or authentication/verification information. However, this information may be lost in transit as intermediate network nodes, such as routers, firewalls, or load balancers in the one or more transit networks and/or terminating network, may have varied configurations and protocols that strip or modify authentication information as the call passes between networks with differing policies or settings. For example, protocol translation is common when calls traverse networks using different signaling protocols or technologies, and network address translation (NAT) or other protocol translation issues between these networks can result in altered headers or removed authentication details. For example, each service provider may enforce unique security policies, including deep packet inspection (DPI), firewalls, or intrusion detection systems, which can modify or strip data elements that do not align with their standards or security requirements. For example, calls transiting through middleware or proxy servers managed by different service providers can experience interference with authentication data, as these systems often handle protocol mediation or load balancing, which could unintentionally modify or drop critical information.

At 830, a public key may be retrieved. The public key may be retrieved based on the determination that the first session invite message is missing information. The public key may be retrieved based on any information remaining in the first session invite message, for example, the one or more identifiers associated with the originating user device. The public key may be one part of a cryptographic key pair used in public-key cryptography. The public key may be configured for encrypting data or verifying digital signatures. The public key may comprise or otherwise be associated with a static value that is associated with an entity. A nonce value may also be retrieved and/or generated. The nonce value may comprise a unique, random, or pseudo-random value generated for one-time use. The nonce value may be configured to ensure that certain actions, like cryptographic operations, are unique and cannot be reused or replayed. The public key and the nonce value may be determined based on determining that the first session invite message is missing information. For example, the first session invite message may be missing one or more identifiers and/or authentication/verification information. Determining the public key and/or the nonce value may comprise querying one or more other devices (e.g., a public key generator device and/or a nonce value generator device) and/or databases to retrieve the public key and/or the nonce value. Additionally and/or alternatively, the public key and the nonce value may be stored on and/or generated by the computing device that received the first session invitation message.

At 840, an intermediate communication session may be established. The intermediate communication session may comprise a temporary communication session established between the computing device and the originating user device for the purpose of authenticating the originating user device. For example, based on determining the first session invite message is missing information, the computing device may send a second session initiation message to the originating user device. The second session initiation message may comprise, for example, a session initiation protocol (SIP) invite. The second session initiation message may comprise one or more of a public key and/or a nonce value.

At 850, a request for the missing information may be sent. For example, the computing device may send the request for the missing information. For example, the request for the missing information may be sent via the intermediate communication channel. The request for the missing information may be sent to the user device. The request for the missing information may transit the one or more transit networks and/or devices associated therewith. The request for the missing information may be a second session invite message. For example, the request for the missing information may comprise an SIP invite (e.g., a second SIP invite). The request for the missing information may comprise one or more identifiers associated with the originating user device, and/or one or more identifiers associated with the computing device and/or any other devise in the terminating network. The request for the missing information may comprise the public key and/or the nonce value. The request for the missing information may be configured to cause the originating user device (and/or one or more applications thereon) to retrieve and/or generate the missing information.

At 860, authentication information may be received. The authentication information may comprise, for example, STIR/SHAKEN information or other authentication/verification information. The authentication information may comprise one or more user identifiers associated with the originating user device. The authentication information may be sent by the originating user device in response to the request for missing information. The authentication information may be received by the computing device.

At 870, the intermediate communication session may be terminated. For example, the intermediate communication session may be terminated based on the authenticating the originating user device. Terminating the intermediate communication session may comprise sending a session termination message to the user device. The session termination message may transit one or more transit networks and/or transit devices associated therewith. For example, the session termination message may comprise an SIP message. For example, the session termination message may comprise an SIP 487 “request terminated” message. The session termination message may be associated with the third session initiation message sent by the originating user device to the computing device. Thus, the session termination message may terminate the intermediate communication session. The SIP 487 may configured to terminate (or complete) the session request (e.g., without setting up an audio session).

At 880, a communication session associated with the first session invite message may be established. The communication session may be the initially requested communication session between the originating user device and the computing device and/or another device in the terminating network. The communication session may be established based on receiving the missing information. The communication session may be established based on an authentication response received from the originating user device.

The method may comprise authenticating, based on receiving the missing authentication information, the originating user device. The method may comprise verifying, based on the authentication information, the originating user device. The method may comprise terminating the initial communication session.

The method may comprise receiving, by a computing device, a first session invite message associated with an originating user device. The method may comprise determining, based on the first session invite message, a public key and a nonce value. The method may comprise sending, to the originating user device, based on the public key, a second session invite message comprising the nonce value. The method may comprise receiving, from the originating user device, based on the second session invite message, an authentication message associated with the public key.

The method may comprise receiving, by a computing device, from an originating user device, a first session invite message. The method may comprise determining the first session invite message is missing authentication information associated with the originating user device. The method may comprise establishing, based on determining the first session invite message is missing authentication information, an intermediate communication session. The method may comprise sending, to the originating user device, via the intermediate communication session, a public key. The method may comprise receiving, based on the public key, from the originating user device, via the intermediate communication session, authentication information. The method may comprise authenticating, based on the authentication information, the originating user device. The method may comprise based on authenticating the originating user device, terminating the intermediate communication session.

The method may comprise receiving, by an originating user device, a first session invite message comprising a public key. The method may comprise associating the first session invite message with a pending service call session. The method may comprise sending the public key to an authentication application on the originating user device. The method may comprise receiving, from the authentication application on the originating user device, a private key. The method may comprise generating, by the originating user device, based on the private key, a second session invite message. The method may comprise sending, to a network device associated with the originating user device, the second session invite message.

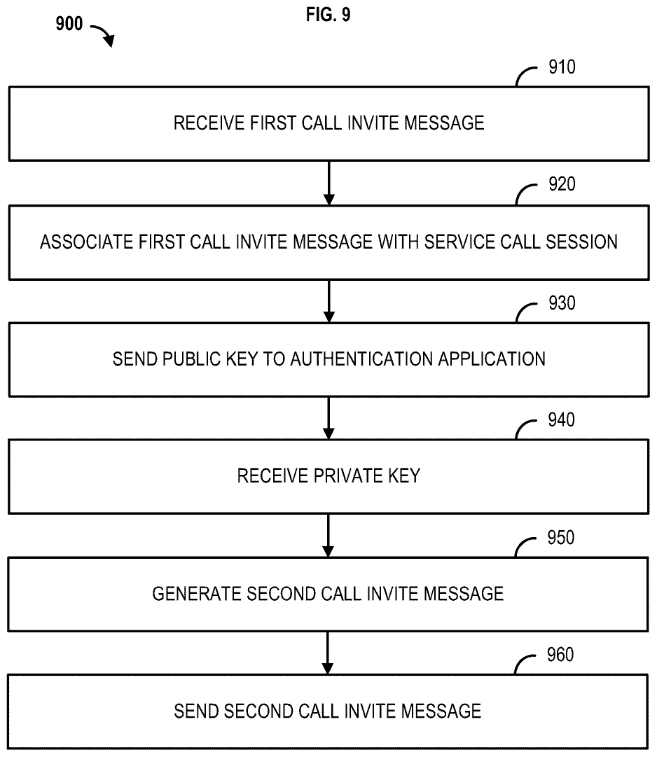

FIG. 9 shows an example method 900. The method 900 may be carried out via any one or more of the devices described herein. At 910, a first session invite message may be received. The first session invite message may be received by an originating user device. The first session invite may comprise an intermediate session invite configured to establish an intermediate communication session. For purposes of explanation, with respect to FIG. 9, the “first session invite message” may or may not be the initial invite message sent or received in any given portion of a communication flow. For example, with respect to FIG. 9, the “first session invite message” may be sent in response to receipt (e.g., by a computing device) a previous communication which may be an invite message. The originating user device may be associated with an originating network. The first session invite message may be sent by a computing device. The computing device may be associated with a terminating network. The originating user device may have sent a previous session invite message to the computing device. The first session invite message may or may not transit one or more transit networks. The first session invite message may be sent based on a determination by the computing device or an associated device in the terminating network that the previous session invite message sent by the originating user device is missing information. For example, the previous session invite message may be sent, by the originating user device, with (e.g., may comprise) one or more identifiers associated with the originating user device and/or the originating network and/or authentication/verification information associated with the originating user device. The one or more identifiers and/or authentication/verification information may be lost or altered as the previous session invite message transits one or more transit networks and/or may be lost or altered by one or more devices in the terminating network.

The first session invite message may comprise a public key. The public key may be retrieved and/or generated by the computing device. The public key may be one part of a cryptographic key pair used in public-key cryptography. The public key may be configured for encrypting data or verifying digital signatures. The public key may comprise or otherwise be associated with a static value that is associated with an entity. The first session invite message may comprise a nonce value. The nonce value may comprise a unique, random, or pseudo-random value generated for one-time use. The nonce value may be configured to ensure that certain actions, like cryptographic operations, are unique and cannot be reused or replayed. The public key and the nonce value may be determined and/or generated based on determining that the first session invite message is missing information. For example, the first session invite message may be missing one or more identifiers and/or authentication/verification information. Determining the public key and/or the nonce value may comprise querying one or more other devices (e.g., a public key generator device and/or a nonce value generator device) and/or databases to retrieve the public key and/or the nonce value. Additionally and/or alternatively, the public key and the nonce value may be stored on and/or generated by the computing device that received the first session invitation message.

At 920, the first session invite message may be associated with a pending call invite message (e.g., the previous call invite message). The pending call invite message may be configured to invoke a device or service associated with the terminating network.

At 930, the public key from the first session invite message may be sent to an authentication application. The authentication application may be resident on the originating user device. The authentication application may be resident on another device associated with the originating network. A service application may send/receive data to/from other devices (e.g., may send/receive one or more session invite messages). The service application may be resident on the originating user device and may be in communication with the authentication/verification application on the originating user device. The service application may be resident on another device associated with the originating network (e.g., an application server).

At 940, a private key may be received. The private key may be received from the authentication/verification application.

At 950, a second session invite message may be generated. The second session invite message may be generated by the originating user device. The second session invite message may comprise, for example, an SIP invite. The second session invite message may comprise the requested authentication/verification information (e.g., an authentication response). For example, the second session invite message may comprise a private key associated with the originating user device.

At 960, the second session invite message may be sent. For example, the second session invite message may be sent by the originating user device. For example, the second session invite message may be sent to the computing device. For example, the second session invite message may transit one or more transit networks in route to the computing device in the terminating network.

The method may comprise receiving a session termination message. The session termination message may comprise a call request termination or cancel message or other similar message.

The method may comprise receiving, by a computing device, a first session invite message associated with an originating user device. The method may comprise determining, based on the first session invite message, a public key and a nonce value. The method may comprise sending, to the originating user device, based on the public key, a second session invite message comprising the nonce value. The method may comprise receiving, from the originating user device, based on the second session invite message, an authentication message associated with the public key.

The method may comprise receiving, by a computing device, from an originating user device, a first session invite message. The method may comprise determining the first session invite message is missing authentication information associated with the originating user device. The method may comprise establishing, based on determining the first session invite message is missing authentication information, an intermediate communication session. The method may comprise sending, to the originating user device, via the intermediate communication session, a public key. The method may comprise receiving, based on the public key, from the originating user device, via the intermediate communication session, authentication information. The method may comprise authenticating, based on the authentication information, the originating user device. The method may comprise based on authenticating the originating user device, terminating the intermediate communication session.

The method may comprise receiving, by a computing device, from an originating user device, a first session invite message requesting an initial communication session, wherein the first session invite message comprises an identifier associated with the originating user device and an identifier associated with a recipient user device. The method may comprise determining the first session invite message is missing authentication information. The method may comprise based on determining the first session invite message is missing authentication information, and based on the identifier associated with the originating user device, retrieving a public key. The method may comprise establishing, between the computing device and the originating user device, an intermediate communication session. The method may comprise sending, via the intermediate communication session, to the originating user device, the public key and a request for the missing authentication information. The method may comprise receiving, the from the originating user device, via the intermediate communication session, authentication information. The method may comprise based on receiving the authentication information, terminating the intermediate communication session. The method may comprise establishing, based on receiving the missing authentication information and based on the identifier associated with the recipient user device, the initial communication session between the originating user device and the recipient user device.

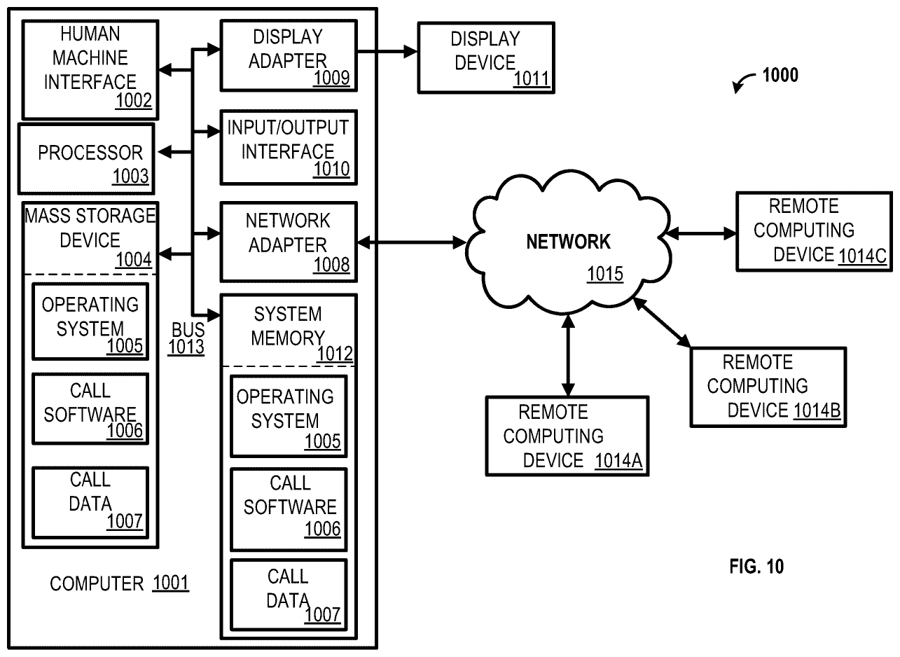

FIG. 10 shows a system 1000 for communication management. Any of the devices of FIG. 1 may be a computer 1001 as shown in FIG. 10. The computer 1001 may comprise one or more processors 1003, a system memory 1012, and a bus 1013 that couples various system components including the one or more processors 1003 to the system memory 1012. In the case of multiple processors 1003, the computer 1001 may utilize parallel computing. The bus 1013 is one or more of several possible types of bus structures, including a memory bus or memory controller, a peripheral bus, an accelerated graphics port, or local bus using any of a variety of bus architectures.

The computer 1001 may operate on and/or comprise a variety of computer readable media (e.g., non-transitory). The computer readable media may be any available media that is accessible by the computer 1001 and may comprise both volatile and non-volatile media, removable and non-removable media. The system memory 1012 has computer readable media in the form of volatile memory, such as random access memory (RAM), and/or non-volatile memory, such as read only memory (ROM). The system memory 1012 may store data such as the call data 1007 and/or program modules such as the operating system 1005 and the call software 1006 that are accessible to and/or are operated on by the one or more processors 1003. The machine learning module may comprise one or more of the call data 1007 and/or the call software 1006.

The computer 1001 may also comprise other removable/non-removable, volatile/non-volatile computer storage media. FIG. 10 shows the mass storage device 1004 which may facilitate non-volatile storage of computer code, computer readable instructions, data structures, program modules, and other data for the computer 1001. The mass storage device 1004 may be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Any quantity of program modules may be stored on the mass storage device 1004, such as the operating system 1005 and the call software 1006. Each of the operating system 1005 and the call software 1006 (or some combination thereof) may comprise elements of the program modules and the call software 1006. The call data 1007 may also be stored on the mass storage device 1004. The call data 1007 may be stored in any of one or more databases known in the art. Such databases may be DB2®, Microsoft® Access, Microsoft® SQL Server, Oracle®, MySQL, PostgreSQL, and the like. The databases may be centralized or distributed across locations within the network 1015.

A user may enter commands and information into the computer 1001 via an input device (not shown). Examples of such input devices comprise, but are not limited to, a keyboard, pointing device (e.g., a computer mouse, remote control), a microphone, a joystick, a scanner, tactile input devices such as gloves, and other body coverings, motion sensor, and the like These and other input devices may be connected to the one or more processors 1003 via a human machine interface 1002 that is coupled to the bus 1013, but may be connected by other interface and bus structures, such as a parallel port, game port, an IEEE 1094 Port (also known as a Firewire port), a serial port, network adapter 1008, and/or a universal serial bus (USB).

The display device 1011 may also be connected to the bus 1013 via an interface, such as the display adapter 1009. It is contemplated that the computer 1001 may comprise more than one display adapter 1009 and the computer 1001 may comprise more than one display device 1011. The display device 1011 may be a monitor, an LCD (Liquid Crystal Display), light emitting diode (LED) display, television, smart lens, smart glass, and/or a projector. In addition to the display device 1011, other output peripheral devices may be components such as speakers (not shown) and a printer (not shown) which may be connected to the computer 1001 via the Input/Output Interface 1010. Any step and/or result of the methods may be output (or caused to be output) in any form to an output device. Such output may be any form of visual representation, including, but not limited to, textual, graphical, animation, audio, tactile, and the like. The display device 1011 and computer 1001 may be part of one device, or separate devices.

The computer 1001 may operate in a networked environment using logical connections to one or more remote computing devices 1014A, B, C. A remote computing device may be a personal computer, computing station (e.g., workstation), portable computer (e.g., laptop, mobile phone, tablet device), smart device (e.g., smartphone, smart watch, activity tracker, smart apparel, smart accessory), security and/or monitoring device, a server, a router, a network computer, a peer device, edge device, and so on. Logical connections between the computer 1001 and a remote computing device 1014A, B, C may be made via a network 1015, such as a local area network (LAN) and/or a general wide area network (WAN). Such network connections may be through the network adapter 1008. The network adapter 1008 may be implemented in both wired and wireless environments. Such networking environments are conventional and commonplace in dwellings, offices, enterprise-wide computer networks, intranets, and the Internet.

Application programs and other executable program components such as the operating system 1005 are shown herein as discrete blocks, although it is recognized that such programs and components reside at various times in different storage components of the computing device 1001, and are executed by the one or more processors 1003 of the computer. An implementation of the call software 1006 may be stored on or sent across some form of computer readable media. Any of the described methods may be performed by processor-executable instructions embodied on computer readable media.

While specific configurations have been described, it is not intended that the scope be limited to the particular configurations set forth, as the configurations herein are intended in all respects to be possible configurations rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the quantity or type of configurations described in the specification.

It will be apparent to those skilled in the art that various modifications and variations may be made without departing from the scope or spirit. Other configurations will be apparent to those skilled in the art from consideration of the specification and practice described herein. It is intended that the specification and described configurations be considered as exemplary only, with a true scope and spirit being indicated by the following claims.

What is claimed is:

1. A method comprising:
receiving, by a computing device, a first session invite message associated with an originating user device;
determining, based on the first session invite message, a public key and a nonce value;
sending, to the originating user device, based on the public key, a second session invite message comprising the nonce value; and
receiving, from the originating user device, based on the second session invite message, an authentication message associated with the public key.

2. The method of claim 1, wherein the first session invite message is a session initiation protocol (SIP) invite and wherein the first session invite message is configured for caller verification.

3. The method of claim 1, wherein the originating user device is associated with an originating network and wherein the computing device is associated with a terminating network.

4. The method of claim 1, wherein sending the second session invite message comprises establishing an intermediate communication session between the computing device and the originating user device.

5. The method of claim 1, further comprising determining the first session invite message is missing one or more of: authentication/verification information or one or more identifiers associated with the originating user device.

6. The method of claim 1, further comprising verifying, based on the authentication message associated with the public key, the originating user device.

7. The method of claim 1, further comprising terminating, based on receiving the authentication message, the intermediate communication session.

8. A method comprising:
receiving, by a computing device, from an originating user device, a first session invite message;
determining the first session invite message is missing authentication information associated with the originating user device;
establishing, based on determining the first session invite message is missing authentication information, an intermediate communication session;
sending, to the originating user device, via the intermediate communication session, a public key;
receiving, based on the public key, from the originating user device, via the intermediate communication session, authentication information;
authenticating, based on the authentication information, the originating user device; and
based on authenticating the originating user device, terminating the intermediate communication session.

9. The method of claim 8, wherein the first session invite message comprises a session initiation protocol (SIP) invite.

10. The method of claim 8, wherein the originating user device is associated with an originating network, wherein the first session invite message is intended for a recipient user device, and wherein the recipient user device is associated with a terminating network.

11. The method of claim 8, wherein the authentication information comprises one or more of:
a private key, an identifier associated with the originating user device, an identifier associated with the computing device, an identifier associated with a recipient user device, or a call history manifest.

12. The method of claim 8, wherein determining the first session invite message is missing authentication information comprises determining one or more of: one or more missing headers or one or more unpopulated headers in the first session invite message.

13. The method of claim 8, wherein authenticating the originating user device comprises determining an association between the authentication information and the public key.

14. The method of claim 8, further comprising:
verifying the originating user device; and
based on verifying the originating user device, sending, to a recipient user device the first session invite message.

15. A method comprising:
receiving, by a computing device, from an originating user device, a first session invite message requesting an initial communication session, wherein the first session invite message comprises an identifier associated with the originating user device and an identifier associated with a recipient user device;
determining the first session invite message is missing authentication information;
based on determining the first session invite message is missing authentication information, and based on the identifier associated with the originating user device, retrieving a public key;
establishing, between the computing device and the originating user device, an intermediate communication session;
sending, via the intermediate communication session, to the originating user device, the public key and a request for the missing authentication information;
receiving, the from the originating user device, via the intermediate communication session, authentication information;
based on receiving the authentication information, terminating the intermediate communication session; and
establishing, based on receiving the missing authentication information and based on the identifier associated with the recipient user device, the initial communication session between the originating user device and the recipient user device.

16. The method of claim 15, wherein the originating user device is associated with an originating network and wherein the computing device and the recipient user device are associated with a terminating network.

17. The method of claim 15, wherein determining the first session invite message is missing authentication information comprises determining data has been dropped from the first session invite message, wherein the data comprises one or more of: one or more packets associated with the first session invite message or one or more packet headers associated with the first session invite message.

18. The method of claim 15, wherein establishing the initial communication session comprises forwarding the first session invite message to the recipient user device.

19. The method of claim 15, further comprising authentication, based on receiving the missing authentication information, the originating user device.

20. The method of claim 15, further comprising:
verifying, based on the authentication information, the originating user device; and
terminating the initial communication session.

21. A method comprising:
receiving, by an originating user device, a first session invite message comprising a public key;
associating the first session invite message with a pending service call session;
sending the public key to an authentication application on the originating user device;
receiving, from the authentication application on the originating user device, a private key;
generating, by the originating user device, based on the private key, a second session invite message; and
sending, to a network device associated with the originating user device, the second session invite message.

22. The method of claim 21, wherein the public key is received by the authentication application from a public key infrastructure associated with the originating user device.

23. The method of claim 21, wherein the first session invite further comprise a nonce value sent by a device in a terminating network.

24. The method of claim 21, wherein the first session invite message is received from a device in a terminating network based on a first session invite message, wherein the first session invite message was missing authentication information.

25. The method of claim 21, wherein the second session invite message comprises one or more of: a calling device identifier, a called device identifier, a first call history comprising an authentication request, a second call history comprising the calling device identifier, or a third call history comprising a called device identifier.

26. The method of claim 21, further comprising receiving, based on the second session invite message, a session termination message.

27. The method of claim 21, further comprising initiating a call cleanup protocol.
